(19) United States
(12) Patent Application Publication
(10) Pub. No.: US 2026/0310701 A1
(43) Pub. Date: Oct. 8, 2026

(54) Generative Agentic System for Processing Multi-Task Queries

(71) Applicant: Google LLC, Mountain View, CA (US)

(72) Inventors: Harshit Kharbanda, Pleasanton, CA (US); Belinda Luna Zeng, Cupertino, CA (US); Louis Wang, San Francisco, CA (US)

(21) Appl. No.: 19/557,893

(22) Filed: Mar. 5, 2026

Related U.S. Application Data
(60) Provisional application No. 63/784,740, filed on Apr. 7, 2025.

(51) Int. Cl. G06F 16/334; G06F 16/332; G06F 16/35; G06F 16/358

(52) U.S. Cl. CPC G06F 16/334; G06F 16/3326; G06F 16/35; G06F 16/358

(57) ABSTRACT

Systems and methods for research-and-synthesis searches can include obtaining a search query, determining the search query is associated with a research-and-synthesis task, generating a model-generated research outline, performing a plurality of searches based on the model-generated research outline, and generating a model-generated response based on the search query, research outline, and search results. The systems and methods can generate the model-generated research outline and the model-generated response with a generative model that interfaces with external tools to obtain the relevant search results.

### RELATED APPLICATIONS

The present application is based on and claims priority to U.S. Provisional Application No. 63/784,740 having a filing date of Apr. 7, 2025. Applicant claims priority to and the benefit of each of such application and incorporate all such application herein by reference in its entirety.

### FIELD

The present disclosure relates generally to leveraging generative agent capabilities for complex search tasks. More particularly, the present disclosure relates to utilizing a generative model to break down a complex research task, invoke a plurality of different searches based on the breakdown, and synthesize the information retrieved from the search results.

### BACKGROUND

Understanding the world at large can be difficult. Whether an individual is trying to understand a topic, trying to understand what the object in front of them is, trying to determine where else the object can be found, and/or trying to determine where an image on the internet was captured from, traditional searching alone can be difficult. In particular, users may struggle to determine which words to use. Additionally, the words may not be descriptive enough and/or abundant enough to generate desired results.

In addition, the content being requested by the user may not be readily available to the user based on the user not knowing where to search and/or based on the storage location of the content.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can include obtaining, by a computing system including one or more processors, a search query. The method can include processing, by the computing system, the search query with a generative model to generate a research outline. The research outline can include an overview topic prompt and a plurality of sub-topic prompts associated with a topic of the overview topic prompt. The method can include generating, by the computing system and with the generative model, a plurality of model-generated queries based on the research outline. The plurality of model-generated queries can include a first model-generated query associated with the overview topic prompt and a plurality of second model-generated queries associated with the plurality of sub-topic prompts. The method can include performing, by the computing system and based on the plurality of model-generated queries, a plurality of searches to determine a plurality of search results sets. Each of the plurality of search results sets can be associated with a different model-generated query of the plurality of model-generated queries. The method can include processing, by the computing system, the search query, the research outline, and at least a subset of each set of the plurality of search results sets with the generative model to generate a model-generated research synthesis. The model-generated research synthesis can include a distillation of information identified from at least the subset of each set of the plurality of search results sets determined to be responsive to the overview topic prompt and the plurality of sub-topic prompts. The method can include providing, by the computing system, the model-generated research synthesis for display.

In some implementations, the method can include processing, by the computing system, the search query with a compact generative model to determine a query task classification. The query classification can be descriptive of at least one of a general search task type, a medical diagnostic task type, or a research task type. When the query classification is descriptive of the general search task type, the method can include processing the search query with a search engine to determine a plurality of general search results and providing the plurality of general search results for display within a search results interface. When the query classification is descriptive of the medical diagnostic task type, the method can include providing an image of the search query to a medical conditions classification model based on the query classification, processing the image with the medical conditions classification model to generate a predicted condition classification, and providing medical condition information associated with the candidate medical condition. In some implementations, the predicted condition classification can be descriptive of a candidate medical condition determined to be potentially depicted in the image. When the query classification is descriptive of the research task type, the method can include transmitting the search query to the generative model.

In some implementations, processing, by the computing system, the search query with the compact generative model to determine the query task classification can include determining, by the computing system and with the compact generative model, that the search query is associated with a research task type and in response to determining, with the compact generative model, that the search query is associated with the research task type, transmitting the search query to a research query processing system. Transmitting the search query to the research query processing system can include transmitting the search query to the generative model.

In some implementations, the generative model may have been trained on chain-of-thought reasoning by training the generative model to breakdown a requested task into sub-tasks then incrementally performing the sub-tasks in order to perform the requested task. The generative model may have been fine-tuned to generate research-focused outlines based on receiving a query. The generative model may be communicatively connected with a plurality of external tools and may have been trained to interface with the plurality of external tools to perform the sub-tasks.

In some implementations, the method can include storing, by the computing system and in a cache, data descriptive of the at least the subset of each set of the plurality of search results sets and the model-generated research synthesis, obtaining a follow-up query, generating a follow-up query response based on a preserved context associated with the data descriptive of the at least the subset of each set of the plurality of search results sets and the model-generated research synthesis stored in the cache, and providing the follow-up query response for display. The follow-up query can be related to a query topic of the search query. In some implementations, the search query can include a text string and an input document. The query can include a multimodal query comprising image data and text data. The generative model can include a vision language model. The research outline can include a multimodal outline.

Another example aspect of the present disclosure is directed to one or more non-transitory computer-readable media that collectively store instructions that, when executed by one or more computing devices, cause the one or more computing devices to perform operations. The operations can include obtaining, via a search interface and from a user computing device, a search query associated with a user request for information. The operations can include determining the search query is associated with a research-and-synthesis search task type. The operations can include processing the search query with a generative model to generate a model-generated question associated with receiving additional information of the user request in response to determining the search query is associated with the research-and-synthesis search task type. The operations can include providing the model-generated question to the user computing device via the search interface. The operations can include obtaining, via the search interface and from the user computing device, an additional input in response to the model-generated question. The operations can include processing the search query and the additional input with the generative model to generate a research outline. The research outline can include an overview topic prompt, a plurality of sub-topic prompts associated with a topic of the overview topic prompt, and a search call associated with a plurality of resources to query to obtain information on the overview topic prompt and the plurality of sub-topic prompts. The operations can include performing, based on the overview topic prompt and the search call, a first search to determine a plurality of first search results associated with the overview topic prompt. In some implementations, the plurality of first search results can be determined by searching a first subset of the plurality of resources based on the search call. The operations can include performing, based on the plurality of sub-topic prompts and the search call, a plurality of second searches to determine a plurality of respective second search result sets associated with the plurality of sub-topic prompts. The plurality of respective second search result sets can be determined by, for each of the plurality of sub-topic prompts, searching a respective second subset of the plurality of resources based on the search call. The operations can include processing the search query, the research outline, at least a subset of the plurality of first search results, and at least a subset of the plurality of respective second search result sets with the generative model to generate a model-generated research synthesis. In some implementations, the model-generated research synthesis can include a detailed and organized distillation of information identified from at least the subset of the plurality of first search results and at least the subset of the plurality of respective second search result sets determined to be responsive to the overview topic prompt and the plurality of sub-topic prompts. The operations can include generating a model-generated response based on the model-generated research synthesis and providing the model-generated response to the user computing device via the search interface.

In some implementations, the operations can include obtaining, via the search interface and from the user computing device, a follow-up query. The follow-up query can be related to a topic of the search query. The operations can include processing the follow-up query and the model-generated research synthesis with the generative model to generate a second model-generated response. The second model-generated response can be responsive to the follow-up query and based on content of the model-generated research synthesis. The operations can include providing the second model-generated response to the user computing device via the search interface. In some implementations, processing the follow-up query and the model-generated research synthesis with the generative model to generate the second model-generated response can include determining, with the generative model and based on the model-generated research synthesis, a particular resource is associated with the follow-up query and processing the follow-up query and the particular resource with the generative model to generate the second model-generated response.

In some implementations, the model-generated response can include a plurality of embedded citations. The plurality of embedded citations can include links to a plurality of respective resources associated with different parts of the model-generated response. The plurality of respective resources can include at least the subset of the plurality of first search results and at least the subset of the plurality of respective second search result sets.

Another example aspect of the present disclosure is directed to a computing system for search result distillation. The system can include one or more processors and one or more non-transitory computer-readable media that collectively store instructions that, when executed by the one or more processors, cause the computing system to perform operations. The operations can include obtaining a query. The query can include a plurality of features. The operations can include processing the query with a search engine to determine a plurality of search results based on the plurality of features. The operations can include processing the query with a classification model to determine a query classification descriptive of a particular query type of a plurality of different query types. The particular query type can be descriptive of the query requesting a research task be performed associated with a broad information request for a particular topic. The operations can include processing the query, a subset of plurality of search results, and a particular prompt with a generative model to generate a plurality of sub-topics and a plurality of sub-topic queries in response to the query classification being descriptive of the particular query type. In some implementations, the plurality of sub-topics can be associated with a topic of information responsive to the query. The plurality of sub-topic queries can be associated with the plurality of sub-topics. The operations can include processing the plurality of sub-topic queries to determine a plurality of sub-topic search result sets. Each of the plurality of sub-topic search result sets can be associated with a different sub-topic query of the plurality of sub-topic queries. The operations can include processing the query, the plurality of sub-topics, and the plurality of sub-topic search result sets with the generative model to generate a multi-part response including a plurality of sub-topic headers and a plurality of sub-topic descriptions. The operations can include providing the multi-part response for display in a search results interface.

In some implementations, the operations can include processing the query with a first query classification model to determine a first query classification and determining to provide the query to the classification model based on the first query classification. The operations can include providing the query and the subset of plurality of search results to the generative model based on the first query classification and processing the query and the subset of plurality of search results with the generative model to generate a first model-generated response. The first model-generated response can include a response to the query generated based on the content of the subset of plurality of search results. The operations can include providing the first model-generated response for display within the search results interface.

In some implementations, the operations can include providing a portion of the plurality of the search results for display with a selectable user interface element associated with preforming generative model processing before processing the query, the subset of the plurality of search results, and the particular prompt with the generative model to generate the plurality of sub-topics and the plurality of sub-topic queries. The operations can include obtaining a selection of the selectable user interface element and providing the query, the subset of the plurality of search results, and the particular prompt to the generative model based on the selection.

In some implementations, providing the multi-part response for display in the search results interface can include providing the multi-part response for display with a portion of the plurality of search results. Processing the query, the plurality of sub-topics, and the plurality of sub-topic search result sets with the generative model to generate the multi-part response can include generating an introduction and a conclusion comprising information responsive to the query, generating the plurality of sub-topic headers based on the plurality of sub-topics, generating the plurality of sub-topic descriptions based on the plurality of sub-topic search result sets, and generating the multi-part response comprising a structured format of the introduction, the plurality of sub-topic headers, the plurality of sub-topic descriptions, and the conclusion.

In some implementations, the plurality of sub-topic queries can include a plurality of model-generated queries generated to obtain information associated with the plurality of sub-topics. The plurality of sub-topic search result sets can be determined based on one or more knowledge graphs. In some implementations, the multi-part response can include the plurality of sub-topic headers are presented in bold. The plurality of sub-topic descriptions can be collapsible within the search results interface. Each of the plurality of sub-topic descriptions can be presented with one or more respective search results from the plurality of sub-topic search result sets.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example research-and-synthesis system according to example embodiments of the present disclosure.

FIG. 2 depicts a block diagram of an example complex search system according to example embodiments of the present disclosure.

FIG. 3 depicts a flow chart diagram of an example method to perform generative agentic-leveraged search according to example embodiments of the present disclosure.

FIG. 4 depicts a block diagram of an example generative agentic system according to example embodiments of the present disclosure.

FIG. 5 depicts a block diagram of an example chat interface system according to example embodiments of the present disclosure.

FIGS. 6A-6B depict a flow chart diagram of an example method to perform research-and-synthesis search task processing according to example embodiments of the present disclosure.

FIG. 7 depicts a flow chart diagram of an example method to perform follow-up query processing according to example embodiments of the present disclosure.

FIG. 8 depicts a flow chart diagram of an example method to perform multi-part response generation according to example embodiments of the present disclosure.

FIG. 9 depicts a block diagram of an example multi-pipeline system according to example embodiments of the present disclosure.

FIG. 10 depicts a block diagram of an example breakdown pipeline system according to example embodiments of the present disclosure.

FIG. 11 depicts a block diagram of an example multi-part response generation system according to example embodiments of the present disclosure.

FIG. 12 depicts an illustration of an example multi-part response according to example embodiments of the present disclosure.

FIG. 13 depicts an illustration of example model-generated responses according to example embodiments of the present disclosure.

FIG. 14A depicts a block diagram of an example computing system that performs search query processing according to example embodiments of the present disclosure.

FIG. 14B depicts a block diagram of an example computing system that performs search query processing according to example embodiments of the present disclosure.

FIG. 15 depicts a flow chart diagram illustrating an example method for training a machine-learned model according to example implementations of aspects of the present disclosure.

FIG. 16 depicts a block diagram of an example processing flow for using machine-learned model(s) to process input(s) to generate output(s) according to example implementations of aspects of the present disclosure.

FIG. 17 depicts a block diagram of an example sequence processing model according to example implementations of aspects of the present disclosure.

FIG. 18 depicts a block diagram of an example technique for populating an example input sequence for processing by a sequence processing model according to example implementations of aspects of the present disclosure.

FIG. 19 depicts a block diagram of an example model development platform according to example implementations of aspects of the present disclosure.

FIG. 20 depicts a block diagram of an example training workflow for training a machine-learned model according to example implementations of aspects of the present disclosure.

FIG. 21 depicts a block diagram of an inference system for operating one or more machine-learned model(s) to perform inference according to example implementations of aspects of the present disclosure.

FIG. 22 depicts a block diagram of an example networked computing system according to example implementations of aspects of the present disclosure.

FIG. 23 depicts a block diagram of an example computing device according to example implementations of aspects of the present disclosure.

FIG. 24 depicts a block diagram of an example computing device according to example implementations of aspects of the present disclosure.

Reference numerals that are repeated across plural figures are intended to identify the same features in various implementations.

### DETAILED DESCRIPTION

Generally, the present disclosure is directed to systems and methods for search queries associated with research-and-synthesis search tasks. In particular, the systems and methods disclosed herein can leverage artificial intelligence agentic systems to identify and respond to complex search queries that are associated with search tasks that rely on multiple sub-tasks to be performed. For example, the systems and methods can obtain a search query. The search query can be processed to determine the search query is descriptive of a research-and-synthesis search task (e.g., “What is the history of the Roman Empire?”, “What are the best hiking boots?”, “How to play chess?”, etc.). In response to determining the search query is associated with a research-and-synthesis search task, the systems and methods can process the search query with a generative model to determine if the search query includes enough context to perform task fulfillment. If the generative model determines more context is needed, the generative model may generate a clarifying question to be served to the user computing device to prompt the user for additional information. Once the generative model determines a threshold amount of context is present, the generative model may process the search query and/or the additional information to generate a model-generated research outline. The model-generated research outline can include an identification of a search topic and a plurality of sub-topics associated with the topic of the search query and/or may include a plurality of resources to query for information on the topic and/or sub-topics. The systems and methods can perform a plurality of searches based on the contents of the model-generated research outline to determine a plurality of search results sets. The generative model can then process the search query, the research outline and at least a subset of the plurality of search results sets to generate a model-generated research synthesis descriptive of a distillation of information on the research topic associated with the search query.

The model-generated research synthesis may then be provided to the user computing device that provided the search query. Alternatively and/or additionally, the systems and methods may include processing the model-generated research synthesis with the generative model to generate a model-generated response to the search query, which can then be provided to the user computing device for display. The model-generated research synthesis and/or the model-generated response may be provided for display with a plurality of search results.

In some implementations, the model-generated research synthesis and/or the plurality of search results may be stored in a cache to be utilized to respond to follow-up queries. For example, the systems and methods may obtain a follow-up query descriptive of a follow-up question on the research topic (e.g., “Who were the leaders of the Roman empire?”). The generative model can process the follow-up query and the model-generated research synthesis to generate a second model-generated response to be provided as output.

A research-focused search and/or other form of multi-part complex search may be utilized by a search system and/or a standalone application for performing a detailed and multi-pronged search to provide a grounded response. Users may leverage the research-focused search and/or other form of multi-part complex search to perform research tasks and/or other synthesis reliant tasks. For example, some search instances can be associated with obtaining information on a plurality of different related objects (e.g., products), events, locations, etc., then distilling down the retrieved information in order to have a better understanding of an overall topic. The systems and methods disclosed herein can identify and perform the plurality of sub-tasks to (1) reduce the search time for the user, (2) reduce redundant searches, and (3) provide a comprehensive and organized response to the complex search query.

Traditional search techniques can provide for quick access to information. However, search engines can struggle to handle complex tasks. In particular, certain tasks may be reliant on significant research and synthesis. Due to the complex nature, a traditional search may only respond to a portion of a query and/or may be off-topic.

The multi-part complex search can leverage chain-of-thought reasoning, contextual/multimodal understanding, artificial intelligence agents, and/or generative models to break down the search task, perform a plurality of searches, and synthesize a response. For example, the search system may receive a deep search request including a search query. The search system can process the search query, ask clarifying questions, process the search query and the clarifying answers to generate a research outline, perform a plurality of searches based on the research outline, generate a synthesized response with a generative model based on the retrieved results, and provide the synthesized response to the user. In some implementations, the user may ask the agent questions that may then be responded to based on the synthesized response.

The multi-part complex search can perform the research for the user in seconds or less. Therefore, multi-hour tasks for the user may be performed quickly and accurately. The feature can ground responses providing trust and integrity in the responses.

The systems and methods disclosed herein can determine a “deep search” is to be performed in place of a traditional search, generate and provide clarifying questions, process the clarifying answers and the query to generate a research outline, perform a plurality of searches based on the different items of the research outline, generate a synthesis response summary, and then provide an interactive interface for answering questions on the topic.

Many “action” and “assistant” tasks can rely on significant research/synthesis, as part of the heavy lifting. Due to the complexity of the research/synthesis, the journeys are largely going unfulfilled by existing search techniques. The tasks may be hyper contextual and multimodal in nature. The tasks may take an enormous amount of time to complete (e.g., sometimes 1-2 hours). If users are utilizing traditional search techniques, the work may be split over many search queries. Leveraging the systems and methods disclosed herein, the system can unlock these journeys. Specifically, the systems and methods can combine chain of thought reasoning, contextual/multimodal understanding, agents, and deep research LLMs (e.g., a specially fine-tuned large language model).

Large language models can provide answers that appear to be logical; however, the models can have factuality issues due to hallucinations. The systems and methods disclosed herein can leverage an agentic generative model to have the generative model invoke searches for obtaining information to ground response generation.

For difficult research tasks, the search may be aided by asking a question to clarify the search requirements, before performing extensive research. Some questions may not be answered with a one-size-fits-all type answer; therefore, clarifying the requirements may be a critical step toward actually getting a helpful answer. The clarification process may be even more valuable when the clarification isn't even one the user would have thought to ask.

In some implementations, the systems and methods may provide for display the train of thought reasoning being performed to provide insight and credibility to the user. In some implementations, the generative model may interface with other models to obtain the relevant information for generating the model-generated research synthesis.

The entry point for the search may be a search interface, a chat interface, and/or other interfaces. For example, the input may be received via a search query input box, a chat interface input element, and/or other interface element. The systems and methods may upload additional context that's helpful (e.g., a PDF, spreadsheet, URL that needs to be referenced, etc.).

In some implementations, the systems and methods may have a minimum set of clarifying questions and/or a maximum number of clarifying questions. After the user responds, the generative model (e.g., a large language model (LLM)) may begin the research task. The generative model can display the research plan (e.g., display the generated research outline) and/or other train of thought outputs. The generative model may pull from many data corpuses. For expert content, the systems and methods may consider the relevant research papers and/or authoritative books on the subject. Once the task is complete, the user may see a synthesized response in a neat summary at the top of a search results page. Users can easily follow up to dig deeper by clicking on expandable sections, if any one area is of interest, and/or asking follow-up questions.

Additionally and/or alternatively, the model-generated research synthesis may be formatted and/or organized similarly to a research paper. However, the research paper format may not be the preferred medium for the user. Therefore, the systems and methods may include processing the model-generated research synthesis to generate a model-generated response that may be more concise and/or more parseable. In some implementations, the model-generated response may include a couple of sentences or a couple of paragraphs that briefly and directly respond to the search query. In some implementations, the model-generated response may include an audio overview that may be generated by utilizing one or more text-to-speech models. The audio overview may be formatted and/or structured in a podcast format. The generated podcast may be stored and/or provided in a separate interface (e.g., a discover interface) and/or may be provided for playback within the search results interface.

In some implementations, the model-generated response may be provided to the user based on generating a selectable interface element within the search results interface, such that when the selectable interface element is selected, the user is navigated to a model-generated webpage that was specifically generated in response to the user's search query. The model-generated webpage may include images, texts, widgets, links, and/or other interactive content items. The model-generated webpage may be rendered based on a script generated by the generative model and may be published based on the generative model interfacing with one or more webpage hoisting platforms.

The systems and methods disclosed herein may be utilized for a plurality of different use cases. For example, the search task may be associated with a shopping research task (e.g., the search may request obtaining information on a plurality of different products of a product type then generate an output that helps a user narrow down which product to purchase). In some implementations, the user shopping experience including user interactions may be tracked for revenue sharing purposes and/or may be tracked for user specific personalization, which may be leveraged for future research-and-synthesis tasks. The search task may be associated with an entertainment research task (e.g., the search may request obtaining information on getting better at a game or other task). The search task may be associated with a financial research task (e.g., the search may request obtaining information on a potential financial management task).

Traditional search techniques can provide for access to information by responding to a search query with a list of search results. However, search engines can struggle to handle complex tasks that rely on significant research and synthesis. Due to the complex nature of such tasks, a traditional search may only respond to a portion of a query or may provide information that is off-topic.

Understanding complex topics can be difficult as relevant information is often scattered across several different search results, with each search result only including a fragment of the information. While some systems provide high-level responses to queries, these responses can lack depth regarding specific sub-topics. Users attempting to perform research tasks using traditional techniques may find that the work is split over many separate search queries, which can take a significant amount of time to complete.

Some large language models can provide answers that appear to be logical but have factuality issues due to hallucinations. For difficult research tasks, a search may be hindered if the system does not clarify search requirements before performing research. Because some queries cannot be answered with a single, generalized response, the absence of a clarification process can lead to results that do not meet the user's specific information needs.

The systems and methods disclosed herein can be utilized for processing search queries associated with research-and-synthesis tasks. A computing system can leverage generative models and agentic processing to identify complex information requests that rely on multiple sub-tasks for fulfillment. In some implementations, the computing system can obtain a search query and can process the search query with a generative model to generate a research outline. The research outline can include an overview topic prompt and a plurality of sub-topic prompts associated with a topic of the overview topic prompt. The computing system can then generate a plurality of model-generated queries based on the research outline, including a first model-generated query for the overview topic prompt and a plurality of second model-generated queries for the sub-topic prompts. Based on these model-generated queries, the computing system can perform a plurality of searches to determine a plurality of search results sets. The search query, the research outline, and at least a subset of the search results sets can then be processed with the generative model to generate a model-generated research synthesis. The synthesis can provide a distillation of information identified from the search results determined to be responsive to the overview topic prompt and the sub-topic prompts.

The systems and methods can provide technical solutions to the problem of information fragmentation and lack of depth in traditional search results. By automatically breaking down a query into a structured research outline and performing targeted searches for each sub-component, the computing system can synthesize a comprehensive response that is grounded in retrieved data. This approach can reduce the time and manual effort required for a user to synthesize information from disparate sources while mitigating the risks of factual inaccuracies. In some implementations, a classification model can be used to determine a query task classification, such as a research task type, to selectively trigger research-and-synthesis processing. The process can increase computational efficiency by limiting intensive generative model operations to queries where such a response is appropriate.

In another aspect, a computing system can generate a multi-part response within a search results interface. The computing system can obtain a query and can determine that the query is associated with a research task. In response, a generative model can process the query and a subset of search results to generate a plurality of sub-topics and corresponding sub-topic queries. These sub-topic queries can be used to determine sub-topic search result sets. The computing system can then process the query, the sub-topics, and/or the sub-topic search result sets to generate a multi-part response including an introduction, a conclusion, and a plurality of sub-topic headers and descriptions. The structured format can allow for an organized presentation of complex topics, where sub-topic descriptions can be provided with respective search results and may be presented in an expandable or collapsible format to enhance information density.

Some implementations can involve a multi-turn interaction to refine the research task. The computing system can determine if a search query includes sufficient context for task fulfillment. If more context is needed, the generative model can generate a model-generated question to obtain additional input from a user. The research outline and subsequent synthesis can then be generated based on both the initial search query and the additional input. Data descriptive of the search results sets and the model-generated research synthesis can be stored in a cache to preserve context. When a follow-up query is obtained, the computing system can generate a follow-up query response based on the preserved context, allowing for seamless and grounded multi-turn research journeys.

In some implementations, the systems and methods disclosed herein can include an advanced, autonomous AI capability designed to act as a virtual research assistant. Unlike standard AI models that provide quick answers based on one or two searches, the system can spend additional inference time conducting a thorough planning-search-reasoning-response loop, which may include multiple search instances, multiple planning instances, and/or multiple reasoning instances. The system may perform a plurality of iterative searches, retrieving and processing academic journals, formatted documents, deep web databases, and/or other content items, autonomously adjusting the search terms and following citation trails to build a comprehensive understanding of complex topics.

During the process, the system can actively reason and course-correct. The generative model can evaluate the credibility and relevance of the sources, pivoting the strategy if the generative model hits dead ends and/or encounters conflicting information. The generative model can process massive amounts of data, synthesizing information for tens or hundreds of web sources and uploaded documents to connect dots across a volume of text and/or other data types that would take a human days or weeks to read.

The generative model can compile the findings into structured outputs rather than simple conversational replies. The outputs can include executive summaries, detailed sections, comparison tables, and/or inline citations that reduce hallucinations and can allow for easy fact-checking. The system can be utilized for complex tasks.

The systems and methods of the present disclosure provide a number of technical effects and benefits. As one example, the systems and methods can provide a dedicated response pipeline for research-and-synthesis responses (e.g., one or more dedicated pipelines can be leveraged for specialized model-generated responses based on search results). In particular, the systems and methods disclosed herein can determine when a search query is associated with a research-and-synthesis search task and can generate specialized model-generated responses based on the determination. The specialized model-generated responses may be generated based on dedicated pipelines that may include generating additional queries, obtaining additional information, and then processing the query and the additional information with a generative model to generate the specialized model-generated response.

Another technical benefit of the systems and methods of the present disclosure is the ability to leverage sub-topic determination, search result processing, query generation, follow-up queries, and/or one or more generative models to generate multi-part structured responses. The multi-part structured responses can be responsive to a query while providing a detailed breakdown of each of a plurality of sub-topics associated with the response.

Another example of technical effect and benefit relates to improved computational efficiency and improvements in the functioning of a computing system. For example, the systems and methods disclosed herein can leverage the classification models to limit the generative model processing to instances determined to be useful for research-and-synthesis. The reduction of generative model processing instances can reduce the computational resources utilized to provide search result interfaces with artificial intelligence options.

With reference now to the Figures, example embodiments of the present disclosure will be discussed in further detail.

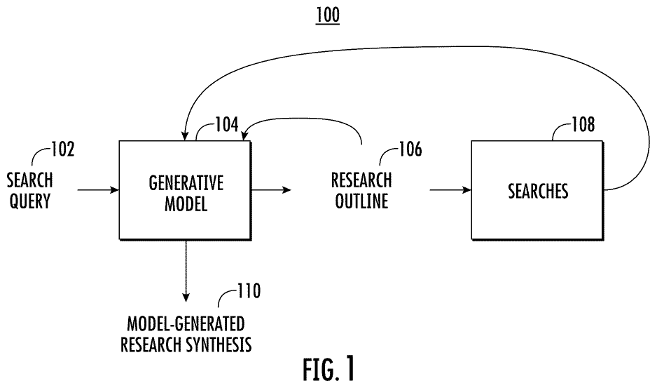

FIG. 1 depicts a block diagram of an example research-and-synthesis system 100 according to example embodiments of the present disclosure. In some implementations, the research-and-synthesis system 100 is configured to receive, and/or obtain, a search query 102 descriptive of a request for information on a topic and, as a result of receipt of the search query 102, generate, determine, and/or provide a model-generated research synthesis 110 that is descriptive of an organized distillation of information on the topic. Thus, in some implementations, the research-and-synthesis system 100 can include a generative model 104 that is operable to plan and orchestrate the information retrieval for the search task and then perform the knowledge identification and organization.

For example, the research-and-synthesis system 100 can obtain a search query 102. The search query can include a text string, an image, a document, and/or other data. The search query 102 can request information on a particular topic. In some implementations, the search query can include a text string and multiple uploaded content items to condition and/or provide context to the search. The multiple uploaded content items can include images, documents, videos, audio files, latent encodings, and/or a mix of content item types.

The research-and-synthesis system 100 can process the search query 102 with a generative model 104 to generate a research outline 106. The generative model 104 may include a pre-trained generative language model fine-tuned and/or configured for chain-of-thought processing and external tool interfacing. The research outline 106 can be descriptive of a research plan associated with different topics and sub-topics to obtain information for and/or a research plan that includes an identification of resources to interface with to obtain the information.

The research-and-synthesis system 100 can perform a plurality of searches 108 based on the research outline 106. The research-and-synthesis system 100 may generate a plurality of model-generated queries based on the plurality of entries within the research outline 106. Additionally and/or alternatively, the generative model 104 may generate a plurality of database calls based on the plurality of entries within the research outline 106. The plurality of searches 108 can be utilized to determine a plurality of search results sets.

The generative model 104 can process the search query 102, the research outline 106, and the plurality of search results sets to generate a model-generated research synthesis 110. The model-generated research synthesis 110 can be descriptive of a distillation of the information identified within the plurality of search results sets in a format that is organized and addresses the request of the search query 112.

The model-generated research synthesis 110 may be processed to generate a model-generated response that is then provided to the user who input the search query 102. The model-generated response may include a multimodal output, which may include text data, image data, audio data, video data, latent encoding data, and/or other data.

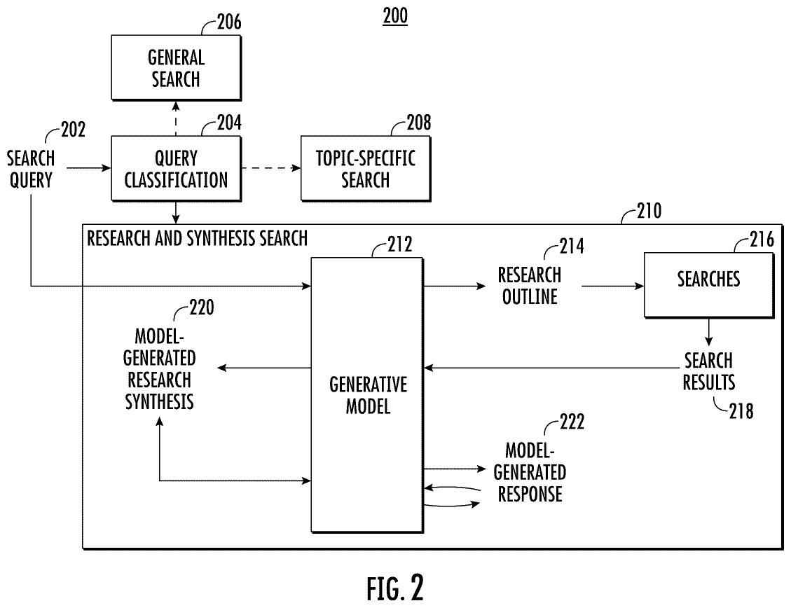

FIG. 2 depicts a block diagram of an example complex search system 200 according to example embodiments of the present disclosure. The complex search system 200 is similar to the research-and-synthesis system 100 of FIG. 1 except that complex search system 200 further includes a query classification block 204.

For example, the complex search system 200 can obtain a search query 202. The search query may include text data, image data, audio data, latent encoding data, rendering data, multimodal data, and/or other data.

A query classification block 204 can process the search query 202 to determine the particular query type of the search query 202. In response to the particular query type, the complex search system 200 can determine the particular search pipeline to utilize. In particular, the complex search system may utilize a classification model and/or a compact generative model to determine whether a general search 206, a topic-specific search (e.g., a medial diagnostic search), a research and synthesis search 210, and/or other form of search pipeline. Each search pipeline may include varying data processing blocks and may query different databases and/or different data types.

The research and synthesis search 210 can include processing the search query 202 with a generative model 212 to generate a research outline 214. The research outline 214 can be utilized to generate a plurality of model-generated queries, which are then utilized to perform a plurality of searches 216. The plurality of searches 216 can be utilized to determine a plurality of search results sets 218.

The generative model 212 can process the search query 202 and the plurality of search results sets 218 to generate a model-generated research synthesis 220. The model-generated research synthesis 220 can include a stylized and organized distillation of the information extracted from the plurality of search results sets 218. The model-generated research synthesis 220 may be structured based on the search query 202 and/or the research outline 214.

The generative model 212 can process the search query 202 and the model-generated research synthesis 220 to generate a model-generated response 222. The model-generated response 222 can be a concise response to the search query 202 that leverages the content of the model-generated research synthesis 220.

In some implementations, the complex search system 200 may obtain follow-up queries that may be responded to based on the generative model processing the follow-up query and the model-generated research synthesis 220 to generate an additional model-generated response.

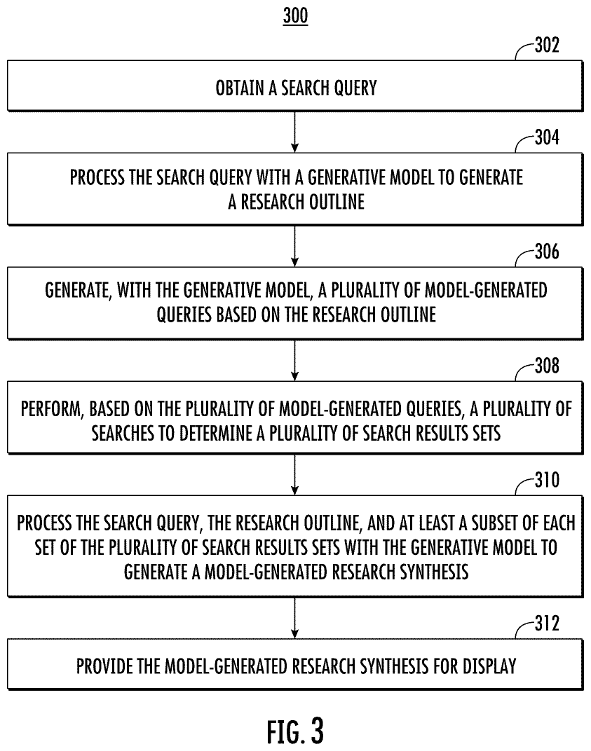

FIG. 3 depicts a flow chart diagram of an example method to perform according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can obtain a search query. In some implementations, the search query can be descriptive of a request for information on a particular subject. The search query can include a multimodal query that includes image data and text data. In some implementations, the search query can include a text string and an input document.

At 304, the computing system can process the search query with a generative model to generate a research outline. The research outline can include an overview topic prompt and a plurality of sub-topic prompts associated with a topic of the overview topic prompt. In some implementations, the generative model may have been trained on chain-of-thought reasoning by training the generative model to breakdown a requested task into sub-tasks then incrementally performing the sub-tasks in order to perform the requested task. The generative model may have been fine-tuned to generate research-focused outlines based on receiving a query. The generative model can be communicatively connected with a plurality of external tools and was trained to interface with the plurality of external tools to perform the sub-tasks. In some implementations, the query can include a multimodal query that includes image data and text data. The generative model can include a vision language model. The research outline can include a multimodal outline. The research outline may include structured text, a plurality of embedding representations, and/or a plurality of tokens.

In some implementations, the computing system can process the search query with a compact generative model to determine a query task classification. The query classification can be descriptive of at least one of a general search task type, a medical diagnostic task type, or a research task type. The compact generative model may include a plurality of classification heads for determining the particular classification.

In some implementations, when the query classification is descriptive of the general search task type, the computing system can process the search query with a search engine to determine a plurality of general search results and provide the plurality of general search results for display within a search results interface. When the query classification is descriptive of the medical diagnostic task type, the computing system can provide an image of the search query to a medical conditions classification model based on the query classification, process the image with the medical conditions classification model to generate a predicted condition classification, and provide medical condition information associated with the candidate medical condition. The predicted condition classification can be descriptive of a candidate medical condition determined to be potentially depicted in the image. When the query classification is descriptive of the research task type, the computing system can transmit the search query to the generative model.

Alternatively and/or additionally, processing the search query with the compact generative model to determine the query task classification can include determining, with the compact generative model, that the search query is associated with a research task type and in response to determining, with the compact generative model, that the search query is associated with the research task type, transmitting the search query to a research query processing system. In some implementations, transmitting the search query to the research query processing system can include transmitting the search query to the generative model.

At 306, the computing system can generate, with the generative model, a plurality of model-generated queries based on the research outline. The plurality of model-generated queries can include a first model-generated query associated with the overview topic prompt and a plurality of second model-generated queries associated with the plurality of sub-topic prompts. In some implementations, the plurality of model-generated queries may include a plurality of text strings, a plurality of multimodal image-text pairs, and/or a plurality of query embeddings generated based on the research outline.

At 308, the computing system can perform, based on the plurality of model-generated queries, a plurality of searches to determine a plurality of search results sets. Each of the plurality of search results sets can be associated with a different model-generated query of the plurality of model-generated queries. The plurality of searches may be performed with one or more search engines and may be performed based on one or more external tool calls generated with the generative model.

At 310, the computing system can process the search query, the research outline, and at least a subset of each set of the plurality of search results sets with the generative model to generate a model-generated research synthesis. The model-generated research synthesis can include a distillation of information identified from at least the subset of each set of the plurality of search results sets determined to be responsive to the overview topic prompt and the plurality of sub-topic prompts. In some implementations, the model-generated research synthesis can include stylized and organized text that provides stylization and organization that emphasizes the different sub-topics and other high-level points associated with the topic of the search task.

At 312, the computing system can provide the model-generated research synthesis for display. The model-generated research synthesis may be provided for display with a plurality of search results, which may include at least a subset of the plurality of search results sets.

In some implementations, the computing system can store, in a cache, data descriptive of the at least the subset of each set of the plurality of search results sets and the model-generated research synthesis, obtain a follow-up query, generate a follow-up query response based on a preserved context associated with the data descriptive of the at least the subset of each set of the plurality of search results sets and the model-generated research synthesis stored in the cache, and provide the follow-up query response for display. The follow-up query can be related to a query topic of the search query.

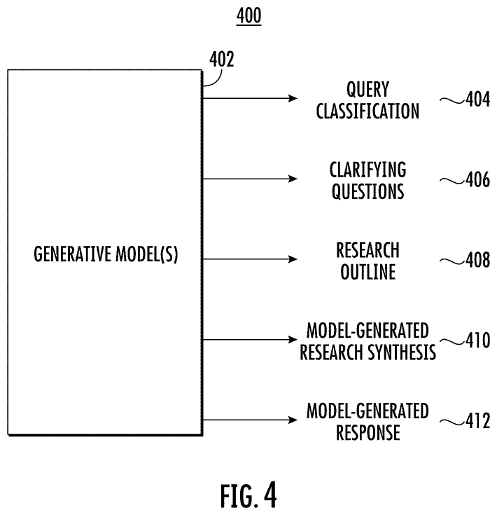

FIG. 4 depicts a block diagram of an example generative agentic system 400 according to example embodiments of the present disclosure. In particular, the generative agentic system 400 can leverage a generative model 402 and/or a plurality of generative models to generate a query classification 404, clarifying questions 406, a research outline 408, a model-generated research synthesis 410, and/or a model-generated response 412. Each output of the generative model 402 may be conditioned on or generated based on the previous output as part of a chain-of-thought reasoning. The generative model 402 may be trained, fine-tuned, and/or configured for each step. In some implementations, the generative model 402 may have been trained and/or fine-tuned via ground truth learning that utilizes a curated set of ground truth task progression outputs.

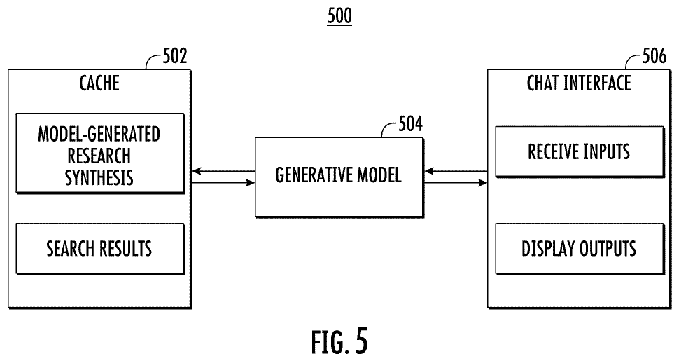

FIG. 5 depicts a block diagram of an example chat interface system 500 according to example embodiments of the present disclosure. In particular, the chat interface system 500 may utilize a cache 502 and a generative model 504 to respond to inputs received via a chat interface 506. For example, the systems and methods disclosed herein may be utilized to identify search results and generate a model-generated research synthesis. The search results and/or the model-generated research synthesis can then be stored in the cache 502.

Upon receiving an input with the chat interface 506, the chat interface 506 can transmit the input to the generative model 504. The generative model 504 can process the input and may obtain the search results and/or the model-generated research synthesis from the cache 502. The generative model 504 can then process the input, the model-generated research synthesis, and/or the search results to generate a model-generated response. The model-generated response can then be provided for display via the chat interface 506.

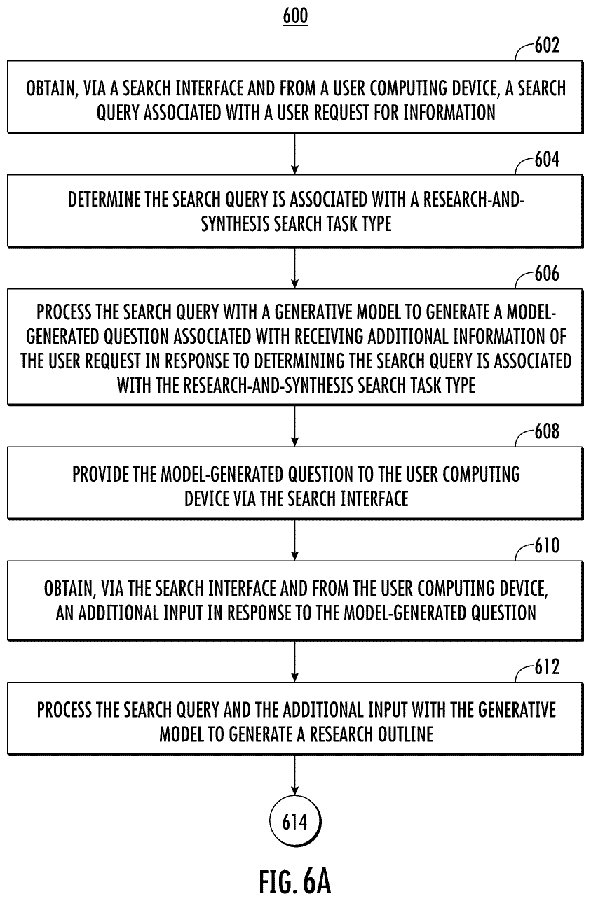

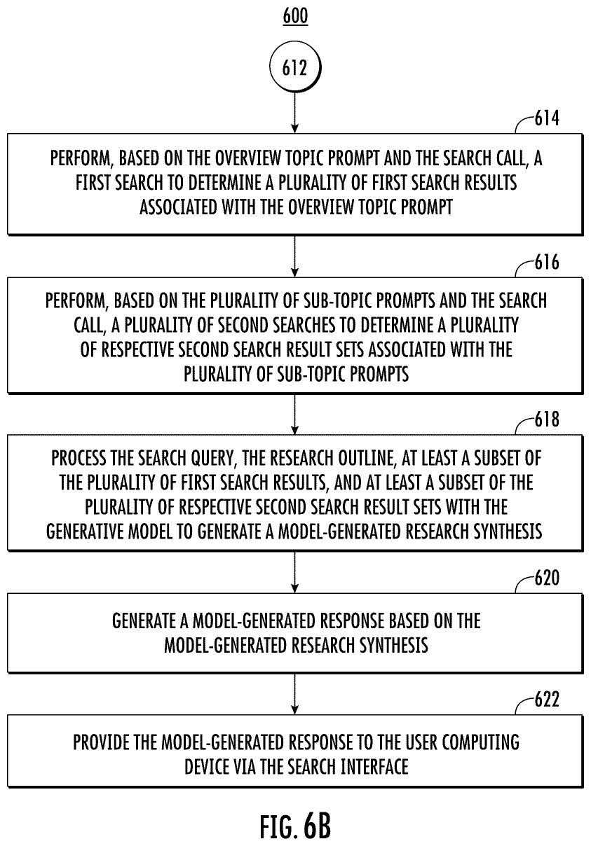

FIGS. 6A-6B depict a flow chart diagram of an example method to perform according to example embodiments of the present disclosure. Although FIGS. 6A-6B depict steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can obtain, via a search interface and from a user computing device, a search query associated with a user request for information. The search query may include a natural language text string, an audio file, an image, a video, a document, a multimodal input, and/or other form of query. In some implementations, the search query may be a proactive query generated by the computing system based on an interaction history of the user.

At 604, the computing system can determine the search query is associated with a research-and-synthesis search task type. Determining the search query is associated with a research-and-synthesis search task type can include processing the search query with one or more classification models to identify a search intent. The query classification may be based on determining the requested information includes a vast amount of information on a particular subject. In some implementations, the query classification may be based at least in part on the topic of the search query.

At 606, the computing system can process the search query with a generative model to generate a model-generated question associated with receiving additional information of the user request in response to determining the search query is associated with the research-and-synthesis search task type. The model-generated question may include a clarifying question to retrieve additional context on the search query.

At 608, the computing system can provide the model-generated question to the user computing device via the search interface. The model-generated question may be provided for display with an initial seat of search results.

At 610, the computing system can obtain, via the search interface and from the user computing device, an additional input in response to the model-generated question. The additional input may be retrieved via a chat interface of the search interface. The chat interface may be a pop-up interface and/or may replace the search query input box.

At 612, the computing system can process the search query and the additional input with the generative model to generate a research outline. The research outline can include an overview topic prompt, a plurality of sub-topic prompts associated with a topic of the overview topic prompt, and a search call associated with a plurality of resources to query to obtain information on the overview topic prompt and the plurality of sub-topic prompts. The research outline may be a model-generated structured output that includes an introduction, a plurality of headers and a plurality of sub-headers, and a plurality of suggested resources to search.

At 614, the computing system can perform, based on the overview topic prompt and the search call, a first search to determine a plurality of first search results associated with the overview topic prompt. The plurality of first search results can be determined by searching a first subset of the plurality of resources based on the search call. The first subset of the plurality of resources may be resources identified in the research outline within an overview topic prompt section.

At 616, the computing system can perform, based on the plurality of sub-topic prompts and the search call, a plurality of second searches to determine a plurality of respective second search result sets associated with the plurality of sub-topic prompts. The plurality of respective second search result sets can be determined by, for each of the plurality of sub-topic prompts, searching a respective second subset of the plurality of resources based on the search call. The respective second subsets of the plurality of resources may be resources identified in the research outline within respective sub-topic prompt sections.

At 618, the computing system can process the search query, the research outline, at least a subset of the plurality of first search results, and at least a subset of the plurality of respective second search result sets with the generative model to generate a model-generated research synthesis. The model-generated research synthesis can include a detailed and organized distillation of information identified from at least the subset of the plurality of first search results and at least the subset of the plurality of respective second search result sets determined to be responsive to the overview topic prompt and the plurality of sub-topic prompts.

At 620, the computing system can generate a model-generated response based on the model-generated research synthesis. In some implementations, the model-generated response can include a plurality of embedded citations. The plurality of embedded citations can include links to a plurality of respective resources associated with different parts of the model-generated response. The plurality of respective resources can include at least the subset of the plurality of first search results and at least the subset of the plurality of respective second search result sets.

At 622, the computing system can provide the model-generated response to the user computing device via the search interface. The model-generated response may be provided for display within a chat interface and/or may be provided for display with the at least the subset of the plurality of first search results and at least the subset of the plurality of respective second search result sets.

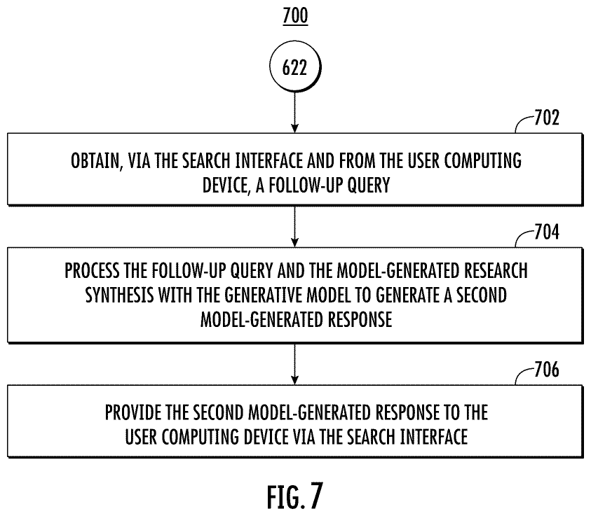

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain, via the search interface and from the user computing device, a follow-up query. The follow-up query can be related to a topic of the search query. The follow-up query may reference the initial query. In some implementations, the follow-up query may include a request associated with a particular sub-topic.

At 704, the computing system can process the follow-up query and the model-generated research synthesis with the generative model to generate a second model-generated response. The second model-generated response can be responsive to the follow-up query and based on content of the model-generated research synthesis. The second model-generated response may include one or more embedded citations.

In some implementations, processing the follow-up query and the model-generated research synthesis with the generative model to generate the second model-generated response can include determining, with the generative model and based on the model-generated research synthesis, a particular resource is associated with the follow-up query and processing the follow-up query and the particular resource with the generative model to generate the second model-generated response.

At 706, the computing system can provide the second model-generated response to the user computing device via the search interface. The follow-up query may be received via a chat interface, and the second model-generated response may be provided for display within the chat interface.

The systems and methods disclosed herein can be leveraged for providing a deep research breakdown option that when selected generates a structured multi-part response to the query. The structured multi-part response can include a model-generated response that is responsive to the query and includes detailed information about a plurality of sub-topics (e.g., three to six sub-topics) associated with the response. For example, the structured multi-part response can include a header (e.g., a descriptive title associated with a main concept of the section) and description for each of the plurality of sub-topics along with a response introduction and a response conclusion.

The structured model-generated multi-part response can be provided in search result interfaces to provide detailed responses to queries that may be complex and may have a multi-faceted answer. Providing the structured model-generated multi-part response with search results can provide an intuitive response to a query and may provide an information primer that a user may build off of when they review the contents of the search results. Generation of the structured model-generated multi-part response may be triggered based on the selection of a user interface element within the search results interface, which may be provided based on the output of one or more query classifiers.

Some topics can be complex and may have several sub-topics that may provide key insight on the topic. Understanding the complex topics from search results can be difficult as the information may be scattered across several different search results with each search result only including a fragment of the relevant information. Moreover, general artificial intelligence responses may provide a high-level response to queries about the topic; however, the responses may lack the key insight associated with the sub-topics.

The systems and methods disclosed herein can generate the structured multi-part response based on the outputs of one or more search engines, one or more generative models, and/or one or more classification models. For example, a query can be obtained from a user computing device. The query can be processed with a first classification model to determine whether an artificial intelligence response option is to be provided (e.g., is the query a candidate for model-generated response generation). If the query is a candidate for model-generated response generation, the query (and/or search results associated with the query) may be processed with a second classification model to determine whether a breakdown option is to be provided (e.g., whether the query is a query type that may be associated with a complex topic that may have multiple sub-topics to breakdown for understanding the topic). The query can be processed with a search engine to determine a plurality of search results. The plurality of search results may then be provided for display with the breakdown option (e.g., a selectable breakdown user interface element).

In response to the breakdown option being selected, the query and the search results can be provided to a generative model (e.g., a machine-learned blueprint model). The generative model (e.g., the machine-learned blueprint model) can process the query and the search results to determine a plurality of sub-topics associated with a response to the query and to generate a plurality of model-generated sub-topic queries based on the plurality of sub-topics. Each of the plurality of model-generated sub-topic queries can be a query generated to obtain additional information associated with a respective sub-topic of the plurality of sub-topics. The plurality of model-generated sub-topic queries can then be processed (e.g., with a search engine) to determine a plurality of sub-topic result sets associated with the plurality of respective model-generated sub-topic queries. The query, the plurality of sub-topics, the plurality of sub-topic result sets, and/or the search results can then be processed with a generative model (e.g., a response generation model) to generate the multi-part response. The multi-part response can include a structured response with an introduction, a conclusion, a plurality of sub-topic headers, and/or a plurality of sub-topic descriptions (which may be collapsable and/or expandable with the search results interface). The multi-part response can then be provided for display within the search results interface.

The multi-part response can provide details about foundational information on topics that may be complex. For example, the response may be associated with a scientific response, while each section of the multi-part response may be associated with a different scientific law or theory that provides backing for the response. Alternatively and/or additionally, the query may be associated with a historical topic, and the response may include a general response to the query along with a plurality of different sections explaining different historical events that may have caused and/or been caused by the historical information that is directly responsive to the query (e.g., the query may be “who won X war?”, the general response may include “Y won the war,” and the different sub-topic sections can be associated with different battles, the final treaty, the aftermath, and/or important people in the war).

The systems and methods of the present disclosure provide a number of technical effects and benefits. As one example, the systems and methods can provide a dedicated response pipeline for broken down and/or simplified responses (e.g., one or more dedicated pipelines can be leveraged for specialized model-generated responses based on search results). In particular, the systems and methods disclosed herein can utilize a plurality of classifications models to determine when a search query is associated with a candidate topic for sub-topic breakdown and/or simplification and can generate specialized model-generated responses based on the determination. The specialized model-generated responses may be generated based on dedicated pipelines that may include generating additional queries, obtaining additional information, and then processing the query and the additional information with a generative model to generate the specialized model-generated response.

Another technical benefit of the systems and methods of the present disclosure is the ability to leverage sub-topic determination, search result processing, query generation, follow-up queries, and/or one or more generative models to generate multi-part structured responses. The multi-part structured responses can be responsive to a query while providing a detailed breakdown of each of a plurality of sub-topics associated with the response.

Another example of technical effect and benefit relates to improved computational efficiency and improvements in the functioning of a computing system. For example, the systems and methods disclosed herein can leverage the classification models to limit the generative model processing to instances determined to be useful for breakdown, simplification, and/or artificial intelligence processing. The reduction of generative model processing instances can reduce the computational resources utilized to provide search result interfaces with artificial intelligence options.

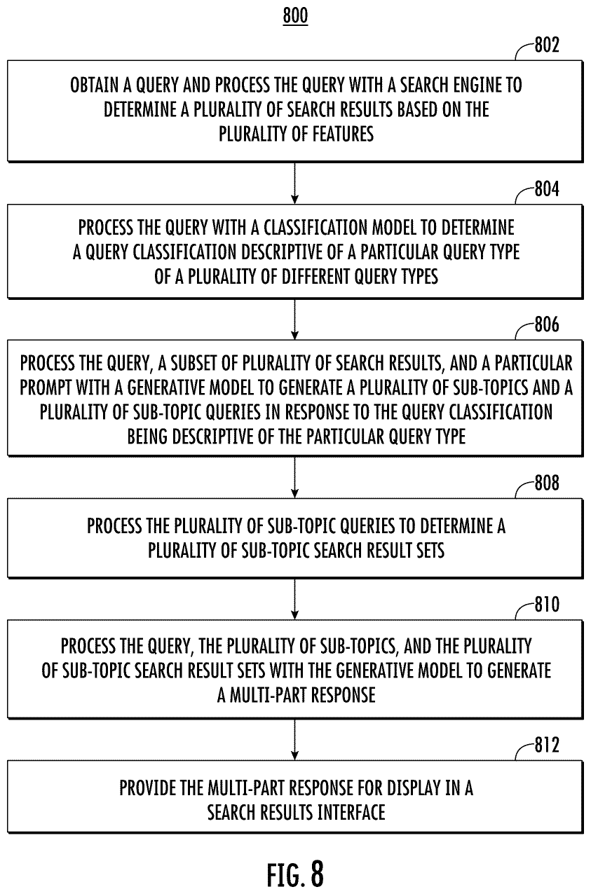

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain a query and process the query with a search engine to determine a plurality of search results based on the plurality of features. The query can include a plurality of features. The query can include text data, image data, audio data, latent encoding data, multimodal data, and/or other data. The plurality of search results may be associated with a plurality of different content items, which may include text, images, videos, audio files, etc.

At 804, the computing system can process the query with a classification model to determine a query classification descriptive of a particular query type of a plurality of different query types. The classification model may be trained to determine whether a query is associated with a particular query type that may cause a user to request a model-generated response. Alternatively and/or additionally, the classification model may be trained to determine whether a query may be associated with an educational response, a multi-faceted response, and/or other complex responses. The particular query type can be descriptive of the query requesting a research task be performed associated with a broad information request for a particular topic.

In some implementations, the computing system can process the query with a first query classification model to determine a first query classification and may determine to provide the query to the classification model based on the first query classification. The computing system can provide the query and the subset of plurality of search results to the generative model based on the first query classification, process the query and the subset of plurality of search results with the generative model to generate a first model-generated response, and provide the first model-generated response for display within the search results interface. The first model-generated response can include a response to the query generated based on the content of the subset of plurality of search results.

At 806, the computing system can process the query, a subset of plurality of search results, and a particular prompt with a generative model to generate a plurality of sub-topics and a plurality of sub-topic queries in response to the query classification being descriptive of the particular query type. The plurality of sub-topics can be associated with a topic of information responsive to the query. In some implementations, the plurality of sub-topic queries can be associated with the plurality of sub-topics. The plurality of sub-topic queries can include a plurality of model-generated queries generated to obtain information associated with the plurality of sub-topics.

In some implementations, the computing system can provide a portion of the plurality of the search results for display with a selectable user interface element associated with performing generative model processing before processing the query, the subset of the plurality of search results, and the particular prompt with the generative model to generate the plurality of sub-topics and the plurality of sub-topic queries. Additionally and/or alternatively, the computing system can obtain a selection of the selectable user interface element and provide the query, the subset of the plurality of search results, and the particular prompt to the generative model based on the selection.

At 808, the computing system can process the plurality of sub-topic queries to determine a plurality of sub-topic search result sets. Each of the plurality of sub-topic search result sets can be associated with a different sub-topic query of the plurality of sub-topic queries. In some implementations, the plurality of sub-topic search result sets can be determined based on one or more knowledge graphs.

At 810, the computing system can process the query, the plurality of sub-topics, and the plurality of sub-topic search result sets with the generative model to generate a multi-part response. The multi-part response can include a plurality of sub-topic headers and a plurality of sub-topic descriptions. Additionally and/or alternatively, the multi-part response may include stylized headers and description sections.

In some implementations, processing the query, the plurality of sub-topics, and the plurality of sub-topic search result sets with the generative model to generate the multi-part response can include generating an introduction and a conclusion including information responsive to the query, generating the plurality of sub-topic headers based on the plurality of sub-topics, generating the plurality of sub-topic descriptions based on the plurality of sub-topic search result sets, and generating the multi-part response. The multi-part response can include a structured format of the introduction, the plurality of sub-topic headers, the plurality of sub-topic descriptions, and the conclusion.

At 812, the computing system can provide the multi-part response for display in a search results interface. In some implementations, providing the multi-part response for display in the search results interface can include providing the multi-part response for display with a portion of the plurality of search results. The multi-part response can include the plurality of sub-topic headers presented in bold. The plurality of sub-topic descriptions may be collapsible within the search results interface. Additionally and/or alternatively, each of the plurality of sub-topic descriptions can be presented with one or more respective search results from the plurality of sub-topic search result sets.

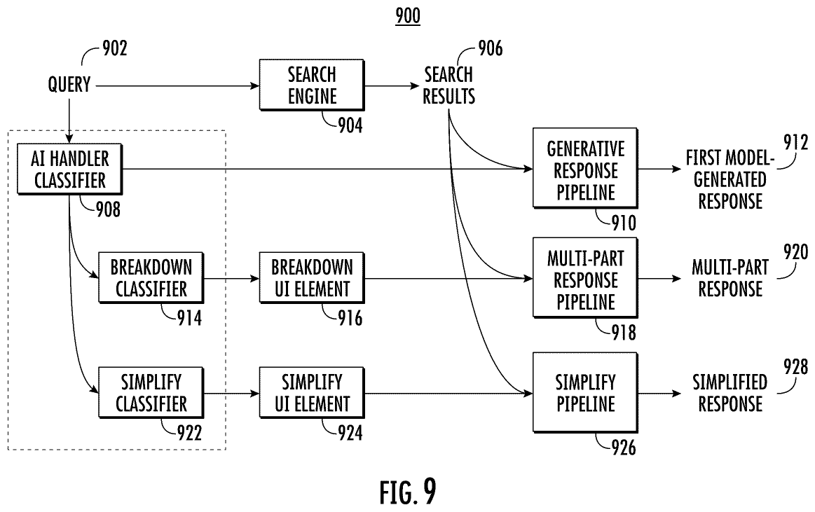

FIG. 9 depicts a block diagram of an example multi-pipeline system 900 according to example embodiments of the present disclosure. In particular, the multi-pipeline system 900 can obtain a query 902, determine a plurality of search results 906, and generate one or more model-generated responses (e.g., a first model-generated response 912, a multi-part response 920, and/or a simplified response 928).

For example, a query 902 can be obtained from a user. The query can be associated with a particular question, problem, and/or request. The query 902 may be associated with one or more topics.

A search engine 904 can process the query 902 to determine a plurality of search results 906 responsive to the query 902. The plurality of search results can include web resources associated with a particular topic of the query 902.

Additionally and/or alternatively, the query 902 can be processed with one or more classifiers to determine whether one or more artificial intelligence options are to be provided to the user to respond to the query 902. For example, the query 902 may be processed with an AI handler classifier 908 to determine whether a general model-generated response 912 is to be generated and/or provided via a generative response pipeline 910. The generative response pipeline 910 may be configured to process the query 902 and at least a subset of the plurality of search results 906 with a generative model to generate a natural language response to the query 902 based on information determined based on the search results 906.

If the query is one or more particular query types (e.g., educational, complex, historical, scientific, and/or one or more other selected query types), the query 902 may then be processed with a breakdown classifier 914 and/or a simplify classifier 922 to determine whether a breakdown option and/or a simplify option is to be provided to the user. Based on the output of the breakdown classifier 914, a selectable breakdown user interface element 916 may be provided for display, which when selected may cause the query 902 and at least a subset of the search results 906 to be processed with a multi-part response pipeline 918 to generate a multi-part response 920. Based on the output of the simplify classifier 922, a selectable simplify user interface element 924 may be provided for display, which when selected may cause the query 902 and at least a subset of the search results 906 to be processed with a simplify pipeline 926 to generate a simplified response 928.

The search results 906, the first model-generated response 912, the multi-part response 920, and/or the simplified response 928 may be provided for display in a search results interface, which may be updated as one or more user interface elements are selected.

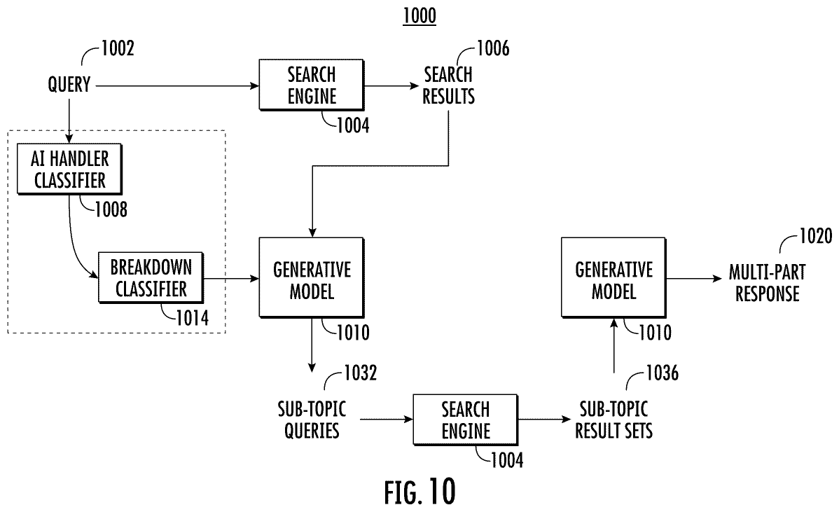

FIG. 10 depicts a block diagram of an example breakdown pipeline system 1000 according to example embodiments of the present disclosure. In particular, the breakdown pipeline system 1000 can obtain a query 1002, determine a plurality of search results 1006 responsive to the query 1002, and then generate a multi-part response 1020 to the query 1002.

For example, the breakdown pipeline system 1000 can obtain a query 1002 via a query input box of a search interface. The query 1002 can be processed with a search engine 1004 to determine a plurality of search results 1006 associated with the query 1002 (e.g., via an embedding based search, a keyword search, and/or other search techniques).

The breakdown pipeline system 1000 can process the query 1002 and/or the search results 1006 with one or more classifiers (e.g., an artificial intelligence (AI) handler classifier 1008 and/or a breakdown classifier 1014) to determine whether the query is associated with a particular query type that is a candidate for providing the breakdown feature (e.g., an option to leverage one or more machine-learned models and one or more search engines to generate a structured model-generated response to the query).

In response to determining the query 1002 is associated with a complex query type and/or complex response type, the breakdown pipeline system 1000 may perform multi-part response generation and/or provide a selectable option to the user to allow a user to select whether to perform the multi-part response generation.

The multi-part response generation can include processing the query 1002 and at least a subset of the search results 1006 with a generative model 1010 (e.g., a blueprint generation model) to generate a blueprint output. The blueprint output can include a plurality of sub-topics determined to be associated with a response to the query 1002 and a plurality of sub-topic queries 1032 generated to obtain additional information on the plurality of sub-topics.

A search engine 1004 and/or other information retrieval system may then process the plurality of sub-topic queries to determine a plurality of sub-topic result sets 1036 responsive to the plurality of sub-topic queries 1032. The query 1002, the blueprint output, and/or the plurality of sub-topic result sets 1036 can then be processed with a generative model 1010 (e.g., a response generation model) to generate the multi-part response 1020. The multi-part response 1020 can include an overview, introduction, and/or conclusion directly responsive to the query 1002, while also including a plurality of sub-topic sections with headers and descriptions that provide additional information on sub-topics associated with the answer to the query 1002. The additional information may be determined based on the content of the plurality of sub-topic result sets 1036.

In some implementations, the multi-part response 1020 can include text images, audio files, videos, and/or other model-generated data. The multi-part response 1020 may include embedded web resources associated with learning more on the one or more sub-topics. The multi-part response 1020 may include different structural and/or stylistic attributes to distinguish the differences between sections, headers, and/or content types.

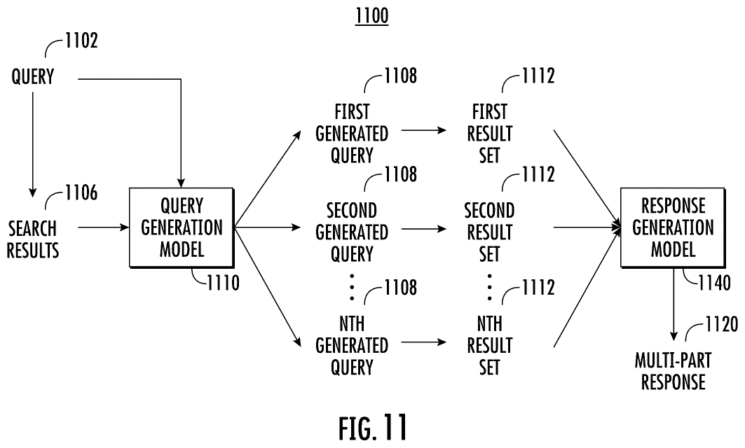

FIG. 11 depicts a block diagram of an example multi-part response generation system 1100 according to example embodiments of the present disclosure. In particular, the multi-part response generation system 1100 can obtain a query 1102, generate sub-topic queries 1108 based on determined sub-topics, obtaining additional information based on the model-generated sub-topic queries 1108, and generating the multi-part response 1120 based on the additional information and the query 1102.

For example, a query 1102 can be obtained and processed to determine a plurality of search results 1106 responsive to the query 1102. The query 1102 and/or the search results 1106 can be processed with a query generation model 1110 (e.g., a large language model fine-tuned for query generation and/or conditioned based on a query generation prompt) to determine sub-topics associated with the topic of the response to the query 1102 and to generate a plurality of model-generated sub-topic queries 1108 based on the determined sub-topics (e.g., a first generated query generated based on a first determined sub-topic, a second generated query generated based on a second determined sub-topic, . . . an nth generated query generated based on an nth determined sub-topic). The sub-topics may be determined based on a semantic understanding of the one or more content items of the one or more search results 1106.

One or more knowledge graphs, one or more search engines, and/or one or more knowledge databases can then be searched based on the plurality of model-generated sub-topic queries 1108 to determine a plurality of sub-topic result sets 1112 (e.g., a first result set may be determined based on the first generated query, a second result set may be determined based on the second generated query, . . . , an nth result set may be determined based on the nth generated query).

The query 1102, the search results 1106, the determined sub-topics, and/or the plurality of sub-topic result sets 1112 can then be processed with a response generation model 1140 (e.g., a large language model fine-tuned for response generation and/or conditioned based on a response generation prompt) to generate the multi-part response 1120. The multi-part response 1120 may include an introduction and conclusion generated based on information obtained from the initial search results 1106 and a plurality of sub-topic sections generated based on information obtained from the plurality of sub-topic result sets 1112.

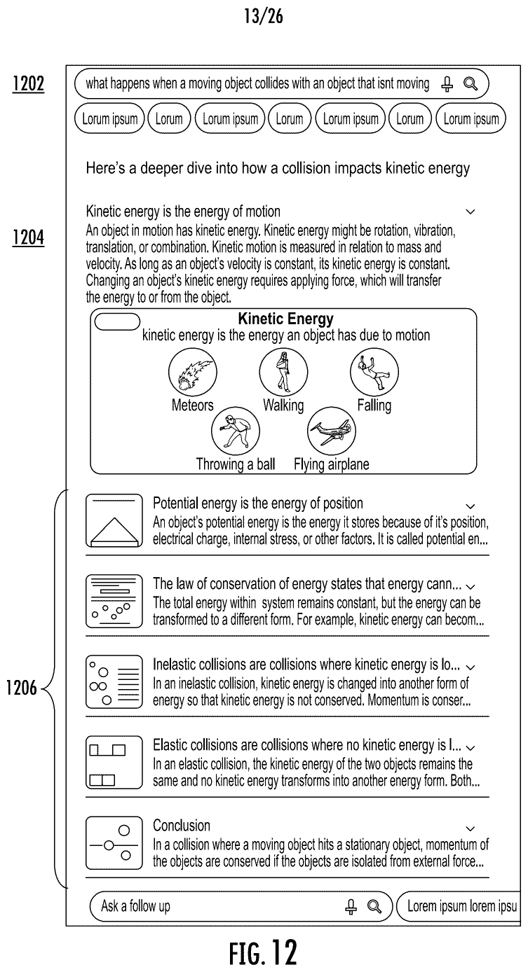

FIG. 12 depicts an illustration of an example multi-part response according to example embodiments of the present disclosure. In particular, FIG. 12 depicts an example multi-part response that is responsive to the query 1202. The multipart response can include a model-generated response overview 1204 and a plurality of expandable model-generated sub-topic content items 1206. The model-generated response overview 1204 can be generated by processing the query 1202 and a plurality of search results to generate a model-generated response to the query 1202 by determining information within the search results that are responsive to the query and then generating a response based on the identified information. The plurality of expandable model-generated sub-topic content items 1206 can include a plurality of sub-topic headers, a plurality of sub-topic descriptions, a plurality of sub-topic images, and/or a plurality of sub-topic web resources.

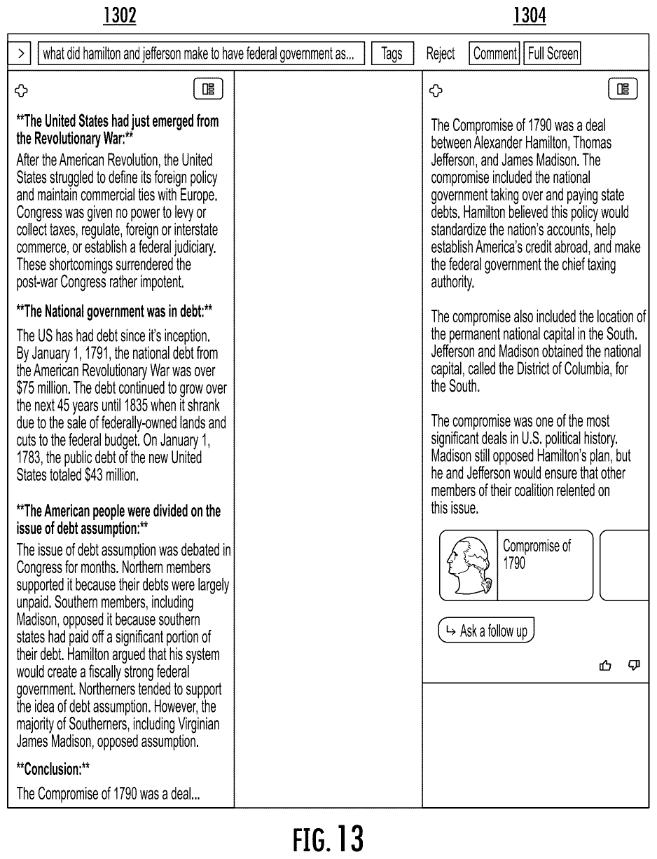

FIG. 13 depicts an illustration of example model-generated responses according to example embodiments of the present disclosure. In particular, FIG. 13 depicts an example structured multipart response 1302 and an example general model-generated response 1304 directed to responding to the same query. In some implementations, the example general model-generated response 1304 may be provided first, and the example structured multipart response 1302 may be generated and provided for display in response to selection of a breakdown option. The example structured multipart response 1302 can include an introduction, a conclusion, section headers, and/or section descriptions.

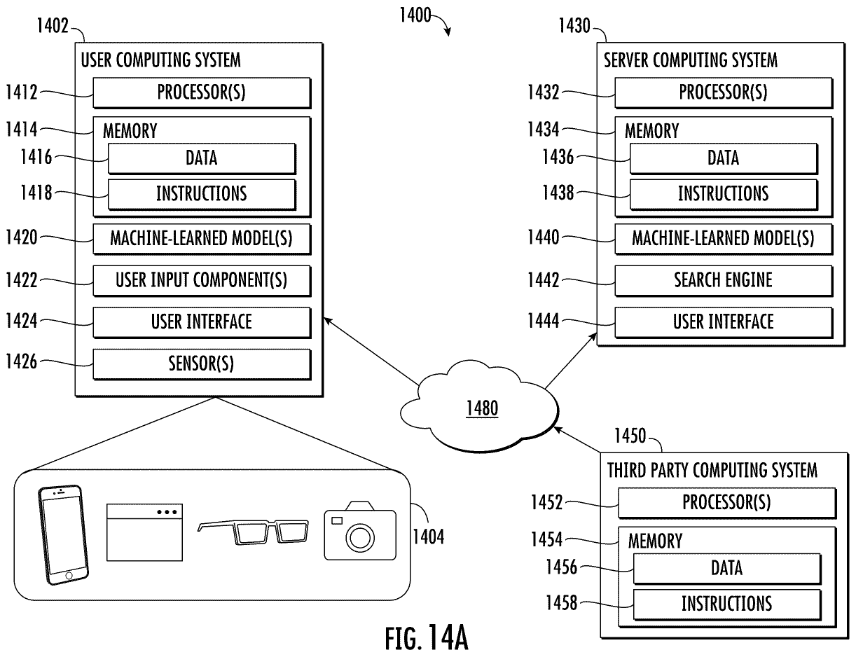

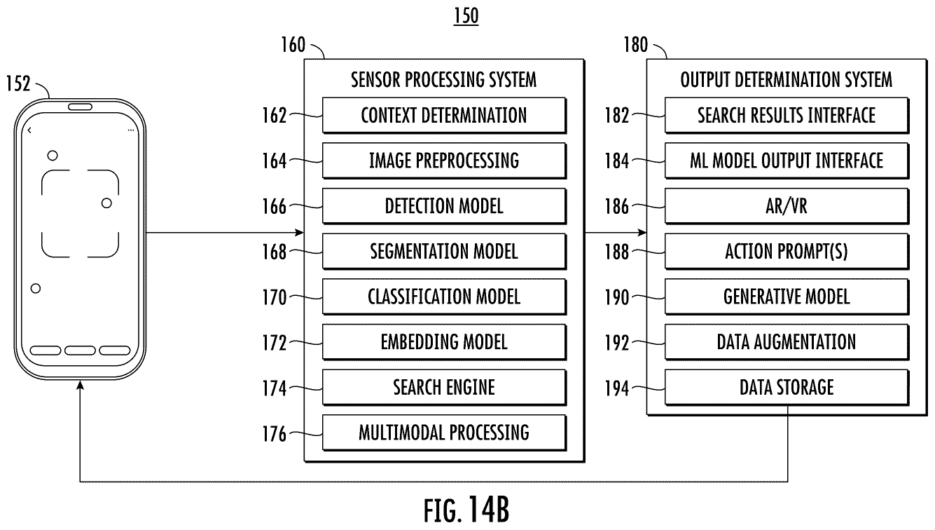

FIG. 14A depicts a block diagram of an example computing system 1400 that performs search query processing according to example embodiments of the present disclosure. The system 1400 includes a user computing system 1402, a server computing system 1430, and/or a third party computing system 1450 that are communicatively coupled over a network 1480.

The user computing system 1402 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 1402 includes one or more processors 1412 and a memory 1414. The one or more processors 1412 can be any suitable processing device (e.g., a processor core, a microprocessor, an ASIC, a FPGA, a controller, a microcontroller, etc.) and can be one processor or a plurality of processors that are operatively connected. The memory 1414 can include one or more non-transitory computer-readable storage mediums, such as RAM, ROM, EEPROM, EPROM, flash memory devices, magnetic disks, etc., and combinations thereof. The memory 1414 can store data 1416 and instructions 1418 which are executed by the processor 1412 to cause the user computing system 1402 to perform operations.

In some implementations, the user computing system 1402 can store or include one or more machine-learned models 1420. For example, the machine-learned models 1420 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 1420 can be received from the server computing system 1430 over network 1480, stored in the user computing device memory 1414, and then used or otherwise implemented by the one or more processors 1412. In some implementations, the user computing system 1402 can implement multiple parallel instances of a single machine-learned model 1420 (e.g., to perform parallel machine-learned model processing across multiple instances of input data and/or detected features).

More particularly, the one or more machine-learned models 1420 may include one or more detection models, one or more classification models, one or more segmentation models, one or more augmentation models, one or more generative models, one or more natural language processing models, one or more optical character recognition models, and/or one or more other machine-learned models. The one or more machine-learned models 1420 can include one or more transformer models. The one or more machine-learned models 1420 may include one or more neural radiance field models, one or more diffusion models, and/or one or more autoregressive language models.

The one or more machine-learned models 1420 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 1420 can process image data, text data, audio data, and/or latent encoding data to generate output data that can include image data, text data, audio data, and/or latent encoding data. The one or more machine-learned models 1420 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Machine-learned model(s) can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) can include a single or multiple instances of the same model configured to operate on data from input(s). Machine-learned model(s) can include an ensemble of different models that can cooperatively interact to process data from input(s). For example, machine-learned model(s) can employ a mixture-of-experts structure. See, e.g., Zhou et al., Mixture-of-Experts with Expert Choice Routing, ARXIV:2202.09368v2 (Oct. 14, 2022).

Input(s) can generally include or otherwise represent various types of data. Input(s) can include one type or many different types of data. Output(s) can be data of the same type(s) or of different types of data as compared to input(s). Output(s) can include one type or many different types of data.

Example data types for input(s) or output(s) include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs or outputs, example combinations of data types include image data and audio data, image data and natural language data, natural language data and software code data, image data and biometric data, sensor data and medical data, etc. It is to be understood that any combination of data types in an input or an output can be present.

An example input can include one or multiple data types, such as the example data types noted above. An example output can include one or multiple data types, such as the example data types noted above. The data type(s) of input can be the same as or different from the data type(s) of output. It is to be understood that the example data types noted above are provided for illustrative purposes only. Data types contemplated within the scope of the present disclosure are not limited to those examples noted above.

Additionally or alternatively, one or more machine-learned models 1440 can be included in or otherwise stored and implemented by the server computing system 1430 that communicates with the user computing system 1402 according to a client-server relationship. For example, the machine-learned models 1440 can be implemented by the server computing system 1430 as a portion of a web service (e.g., a viewfinder service, a visual search service, an image processing service, an ambient computing service, and/or an overlay application service). Thus, one or more models 1420 can be stored and implemented at the user computing system 1402 and/or one or more models 1440 can be stored and implemented at the server computing system 1430.

The user computing system 1402 can also include one or more user input components 1422 that receives user input. For example, the user input component 1422 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system 1402 can store and/or provide one or more user interfaces 1424, which may be associated with one or more applications. The one or more user interfaces 1424 can be configured to receive inputs and/or provide data for display (e.g., image data, text data, audio data, one or more user interface elements, an augmented-reality experience, a virtual reality experience, and/or other data for display. The user interfaces 1424 may be associated with one or more other computing systems (e.g., server computing system 1430 and/or third party computing system 1450). The user interfaces 1424 can include a viewfinder interface, a search interface, a generative model interface, a social media interface, and/or a media content gallery interface.

The user computing system 1402 may include and/or receive data from one or more sensors 1426. The one or more sensors 1426 may be housed in a housing component that houses the one or more processors 1412, the memory 1414, and/or one or more hardware components, which may store, and/or cause to perform, one or more software packets. The one or more sensors 1426 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The user computing system 1402 may include, and/or be part of, a user computing device 1404. The user computing device 1404 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more user computing devices 1404. For example, a camera of a smartphone may be utilized to capture image data descriptive of the environment, and/or an overlay application of the user computing device 1404 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The server computing system 1430 includes one or more processors 1432 and a memory 1434. The one or more processors 1432 can be any suitable processing device (e.g., a processor core, a microprocessor, an ASIC, a FPGA, a controller, a microcontroller, etc.) and can be one processor or a plurality of processors that are operatively connected. The memory 1434 can include one or more non-transitory computer-readable storage mediums, such as RAM, ROM, EEPROM, EPROM, flash memory devices, magnetic disks, etc., and combinations thereof. The memory 1434 can store data 1436 and instructions 1438 which are executed by the processor 1432 to cause the server computing system 1430 to perform operations.

In some implementations, the server computing system 1430 includes or is otherwise implemented by one or more server computing devices. In instances in which the server computing system 1430 includes plural server computing devices, such server computing devices can operate according to sequential computing architectures, parallel computing architectures, or some combination thereof.

As described above, the server computing system 1430 can store or otherwise include one or more machine-learned models 1440. For example, the models 1440 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 1440 are discussed with reference to FIG. 14B.

Additionally and/or alternatively, the server computing system 1430 can include and/or be communicatively connected with a search engine 1442 that may be utilized to crawl one or more databases (and/or resources). The search engine 1442 can process data from the user computing system 1402, the server computing system 1430, and/or the third party computing system 1450 to determine one or more search results associated with the input data. The search engine 1442 may perform term based search, label based search, Boolean based searches, image search, embedding based search (e.g., nearest neighbor search), multimodal search, and/or one or more other search techniques.

The server computing system 1430 may store and/or provide one or more user interfaces 1444 for obtaining input data and/or providing output data to one or more users. The one or more user interfaces 1444 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 1402 and/or the server computing system 1430 can train the models 1420 and/or 1440 via interaction with the third party computing system 1450 that is communicatively coupled over the network 1480. The third party computing system 1450 can be separate from the server computing system 1430 or can be a portion of the server computing system 1430. Alternatively and/or additionally, the third party computing system 1450 may be associated with one or more web resources, one or more web platforms, one or more other users, and/or one or more contexts.

An example machine-learned model can include a generative model (e.g., a large language model, a foundation model, a vision language model, an image generation model, a text-to-image model, an audio generation model, and/or other generative models).

Training and/or tuning the machine-learned model can include obtaining a training instance. A set of training data can include a plurality of training instances divided between multiple datasets (e.g., a training dataset, a validation dataset, or testing dataset). A training instance can be labeled or unlabeled. The runtime inferences can form training instances when a model is trained using an evaluation of the model's performance on that runtime instance (e.g., online training/learning). Example data types for the training instance and various tasks associated therewith are described throughout the present disclosure.

The third party computing system 1450 can include one or more processors 1452 and a memory 1454. The one or more processors 1452 can be any suitable processing device (e.g., a processor core, a microprocessor, an ASIC, a FPGA, a controller, a microcontroller, etc.) and can be one processor or a plurality of processors that are operatively connected. The memory 1454 can include one or more non-transitory computer-readable storage mediums, such as RAM, ROM, EEPROM, EPROM, flash memory devices, magnetic disks, etc., and combinations thereof. The memory 1454 can store data 1456 and instructions 1458 which are executed by the processor 1452 to cause the third party computing system 1450 to perform operations. In some implementations, the third party computing system 1450 includes or is otherwise implemented by one or more server computing devices.

The network 1480 can be any type of communications network, such as a local area network (e.g., intranet), wide area network (e.g., Internet), or some combination thereof and can include any number of wired or wireless links. In general, communication over the network 1480 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, the task can be a generative task, and the one or more machine-learned models (e.g., 1420 and/or 1440) can be configured to output content generated in view of one or more inputs. For instance, the inputs can be or otherwise represent data of one or more modalities that encodes context for generating additional content.

In some implementations, the task can be a text completion task. The machine-learned models can be configured to process the inputs that represent textual data and to generate the outputs that represent additional textual data that completes a textual sequence that includes the inputs. For instance, the machine-learned models can be configured to generate the outputs to complete a sentence, paragraph, or portion of text that follows from a portion of text represented by inputs.

In some implementations, the task can be an instruction following task. The machine-learned models can be configured to process the inputs that represent instructions to perform a function and to generate the outputs that advance a goal of satisfying the instruction function (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the instructions (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the instructions (e.g., natural language responses, programming language responses, machine language responses, etc.). One or more outputs can be iteratively or recursively generated to sequentially process and accomplish steps toward accomplishing the requested functionality. For instance, an initial output can be executed by an external system or be processed by the machine-learned models to complete an initial step of performing a function. Multiple steps can be performed, with a final output being obtained that is responsive to the initial instructions.

In some implementations, the task can be a question answering task. The machine-learned models can be configured to process the inputs that represent a question to answer and to generate the outputs that advance a goal of returning an answer to the question (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the question (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the question (e.g., natural language responses, programming language responses, machine language responses, etc.). One or more outputs can be iteratively or recursively generated to sequentially process and accomplish steps toward answering the question. For instance, an initial output can be executed by an external system or be processed by the machine-learned models to complete an initial step of obtaining an answer to the question (e.g., querying a database, performing a computation, executing a script, etc.). Multiple steps can be performed, with a final output being obtained that is responsive to the question.

In some implementations, the task can be an image generation task. The machine-learned models can be configured to process the inputs that represent context regarding a desired portion of image content. The context can include text data, image data, audio data, etc. Machine-learned models can be configured to generate the outputs that represent image data that depicts imagery related to the context. For instance, the machine-learned models can be configured to generate pixel data of an image. Values for channels associated with the pixels in the pixel data can be selected based on the context (e.g., based on a probability determined based on the context).

In some implementations, the task can be an audio generation task. Machine-learned models can be configured to process the inputs that represent context regarding a desired portion of audio content. The context can include text data, image data, audio data, etc. The machine-learned models can be configured to generate the outputs that represent audio data related to the context. For instance, the machine-learned models can be configured to generate waveform data in the form of an image (e.g., a spectrogram). Values for channels associated with pixels of the image can be selected based on the context. The machine-learned models can be configured to generate waveform data in the form of a sequence of discrete samples of a continuous waveform. Values of the sequence can be selected based on the context (e.g., based on a probability determined based on the context).

In some implementations, the task can be a data generation task. Machine-learned models can be configured to process the inputs that represent context regarding a desired portion of data (e.g., data from various data domains, such as sensor data, image data, multimodal data, statistical data, etc.). The desired data can be, for instance, synthetic data for training other machine-learned models. The context can include arbitrary data types. The machine-learned models can be configured to generate the outputs that represent data that aligns with the desired data. For instance, the machine-learned models can be configured to generate data values for populating a dataset. Values for the data objects can be selected based on the context (e.g., based on a probability determined based on the context).

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 1402 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing system 1400.

The central intelligence layer can communicate with a central device data layer. The central device data layer can be a centralized repository of data for the computing system 1400. The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 14B depicts a block diagram of an example computing system 150 that performs search query processing according to example embodiments of the present disclosure. In particular, the example computing system 150 can include one or more computing devices 152 that can be utilized to obtain, and/or generate, one or more datasets that can be processed by a sensor processing system 160 and/or an output determination system 180 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 152 (e.g., one or more sensors in the computing device 152). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 152 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 160. The sensor processing system 160 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 162, which may determine a context associated with one or more content items. The context determination block 162 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 160 may include an image preprocessing block 164. The image preprocessing block 164 may be utilized to adjust one or more values of an obtained and/or received image to prepare the image to be processed by one or more machine-learned models and/or one or more search engines 174. The image preprocessing block 164 may resize the image, adjust saturation values, adjust resolution, strip and/or add metadata, and/or perform one or more other operations.

In some implementations, the sensor processing system 160 can include one or more machine-learned models, which may include a detection model 166, a segmentation model 168, a classification model 170, an embedding model 172, and/or one or more other machine-learned models. For example, the sensor processing system 160 may include one or more detection models 166 that can be utilized to detect particular features in the processed dataset. In particular, one or more images can be processed with the one or more detection models 166 to generate one or more bounding boxes associated with detected features in the one or more images.

Additionally and/or alternatively, one or more segmentation models 168 can be utilized to segment one or more portions of the dataset from the one or more datasets. For example, the one or more segmentation models 168 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 170 can be utilized to process image data, text data, audio data, latent encoding data, multimodal data, and/or other data to generate one or more classifications. The one or more classification models 170 can include one or more image classification models, one or more object classification models, one or more text classification models, one or more audio classification models, and/or one or more other classification models. The one or more classification models 170 can process data to determine one or more classifications.

In some implementations, data may be processed with one or more embedding models 172 to generate one or more embeddings. For example, one or more images can be processed with the one or more embedding models 172 to generate one or more image embeddings in an embedding space. The one or more image embeddings may be associated with one or more image features of the one or more images. In some implementations, the one or more embedding models 172 may be configured to process multimodal data to generate multimodal embeddings. The one or more embeddings can be utilized for classification, search, and/or learning embedding space distributions.

The sensor processing system 160 may include one or more search engines 174 that can be utilized to perform one or more searches. The one or more search engines 174 may crawl one or more databases (e.g., one or more local databases, one or more global databases, one or more private databases, one or more public databases, one or more specialized databases, and/or one or more general databases) to determine one or more search results. The one or more search engines 174 may perform feature matching, text based search, embedding based search (e.g., k-nearest neighbor search), metadata based search, multimodal search, web resource search, image search, text search, and/or application search.

Additionally and/or alternatively, the sensor processing system 160 may include one or more multimodal processing blocks 176, which can be utilized to aid in the processing of multimodal data. The one or more multimodal processing blocks 176 may include generating a multimodal query and/or a multimodal embedding to be processed by one or more machine-learned models and/or one or more search engines 174.

The output(s) of the sensor processing system 160 can then be processed with an output determination system 180 to determine one or more outputs to provide to a user. The output determination system 180 may include heuristic based determinations, machine-learned model based determinations, user selection based determinations, and/or context based determinations.

The output determination system 180 may determine how and/or where to provide the one or more search results in a search results interface 182. Additionally and/or alternatively, the output determination system 180 may determine how and/or where to provide the one or more machine-learned model outputs in a machine-learned model output interface 184. In some implementations, the one or more search results and/or the one or more machine-learned model outputs may be provided for display via one or more user interface elements. The one or more user interface elements may be overlayed over displayed data. For example, one or more detection indicators may be overlaid over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 160 may be utilized to generate and/or provide an augmented-reality experience and/or a virtual-reality experience 186. For example, the one or more obtained datasets may be processed to generate one or more augmented-reality rendering assets and/or one or more virtual-reality rendering assets, which can then be utilized to provide an augmented-reality experience and/or a virtual-reality experience 186 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 188 may be determined based on the output(s) of the sensor processing system 160. For example, a search prompt, a purchase prompt, a generate prompt, a reservation prompt, a call prompt, a redirect prompt, and/or one or more other prompts may be determined to be associated with the output(s) of the sensor processing system 160. The one or more action prompts 188 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 160 may be processed with one or more generative models 190 to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models 190 can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models 190 can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models 190 can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models 190 can be trained to process input data and generate model-generated content items, which may include a plurality of predicted words, pixels, signals, and/or other data. The model-generated content items may include novel content items that are not the same as any pre-existing work. The one or more generative models 140 can leverage learned representations, sequences, and/or probability distributions to generate the content items, which may include phrases, storylines, settings, objects, characters, beats, lyrics, and/or other aspects that are not included in pre-existing content items.

The one or more generative models 190 may include a vision language model.

The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g., for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The one or more generative models 190 may be stored on-device and/or may be stored on a server computing system. In some implementations, the one or more generative models 190 can perform on-device processing to determine suggested searches, suggested actions, and/or suggested prompts. The one or more generative models 190 may include one or more compact vision language models that may include less parameters than a vision language model stored and operated by the server computing system. The compact vision language model may be trained via distillation training. In some implementations, the visional language model may process the display data to generate suggestions. The display data can include a single image descriptive of a screenshot and/or may include image data, metadata, and/or other data descriptive of a period of time preceding the current displayed content (e.g., the applications, images, videos, messages, and/or other content viewed within the past 30 seconds). The user computing device may generate and store a rolling buffer window (e.g., 30 seconds) of data descriptive of content displayed during the buffer. Once the time has elapsed, the data may be deleted. The rolling buffer window data may be utilized to determine a context, which can be leveraged for query, content, action, and/or prompt suggestion.

In some implementations, the generative models 190 can include machine-learned sequence processing models. An example system can pass inputs to sequence processing models. Sequence processing models can include one or more machine-learned components. Sequence processing models can process the data from inputs to obtain an input sequence. Input sequence can include one or more input elements obtained from inputs. The sequence processing model can process the input sequence using prediction layers to generate an output sequence. The output sequence can include one or more output elements generated based on input sequence. The system can generate outputs based on output sequence.

The output determination system 180 may process the one or more datasets and/or the output(s) of the sensor processing system 160 with a data augmentation block 192 to generate augmented data. For example, one or more images can be processed with the data augmentation block 192 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 160 may be stored based on a data storage block 194 determination.

The output(s) of the output determination system 180 can then be provided to a user via one or more output components of the user computing device 152. For example, one or more user interface elements associated with the one or more outputs can be provided for display via a visual display of the user computing device 152.

The processes may be performed iteratively and/or continuously. One or more user inputs to the provided user interface elements may condition and/or affect successive processing loops.

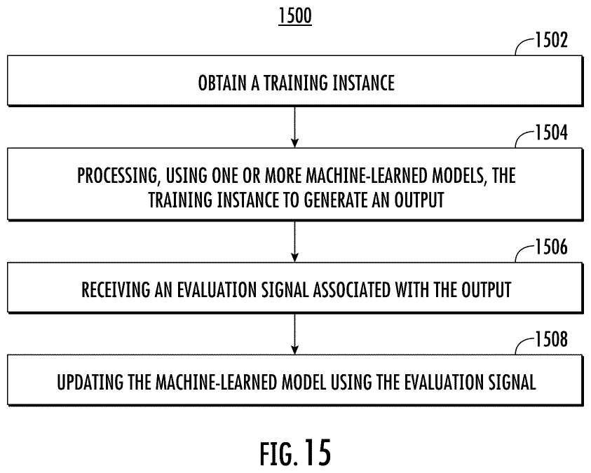

FIG. 15 depicts a flowchart of a method 1500 for training one or more machine-learned models according to aspects of the present disclosure. For instance, an example machine-learned model can include a generative model (e.g., a large language model), a classification model, a computer vision model, and/or other machine-learned model.

One or more portion(s) of example method 1500 can be implemented by a computing system that includes one or more computing devices such as, for example, computing systems described with reference to the other figures. Each respective portion of example method 1500 can be performed by any (or any combination) of one or more computing devices. Moreover, one or more portion(s) of example method 1500 can be implemented on the hardware components of the device(s) described herein, for example, to train one or more systems or models. FIG. 15 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 15 is described with reference to elements/terms described with respect to other systems and figures for exemplary illustrated purposes and is not meant to be limiting. One or more portions of example method 1500 can be performed additionally, or alternatively, by other systems.

At 1502, example method 1500 can include obtaining a training instance. A set of training data can include a plurality of training instances divided between multiple datasets (e.g., a training dataset, a validation dataset, or testing dataset). A training instance can be labeled or unlabeled. Although referred to in example method 1500 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1504, example method 1500 can include processing, using one or more machine-learned models, the training instance to generate an output. The output can be directly obtained from the one or more machine-learned models or can be a downstream result of a chain of processing operations that includes an output of the one or more machine-learned models.

At 1506, example method 1500 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1508, example method 1500 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1500 can include implementing a number of generalization techniques (e.g., weight decays, dropouts, etc.) to improve the generalization capability of the models being trained.

In some implementations, example method 1500 can be implemented for training a machine-learned model from an initialized state to a fully trained state (e.g., when the model exhibits a desired performance profile, such as based on accuracy, precision, recall, etc.).

In some implementations, example method 1500 can be implemented for particular stages of a training procedure. For instance, in some implementations, example method 1500 can be implemented for pre-training a machine-learned model. Pre-training can include, for instance, large-scale training over potentially noisy data to achieve a broad base of performance levels across a variety of tasks/data types. In some implementations, example method 1500 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

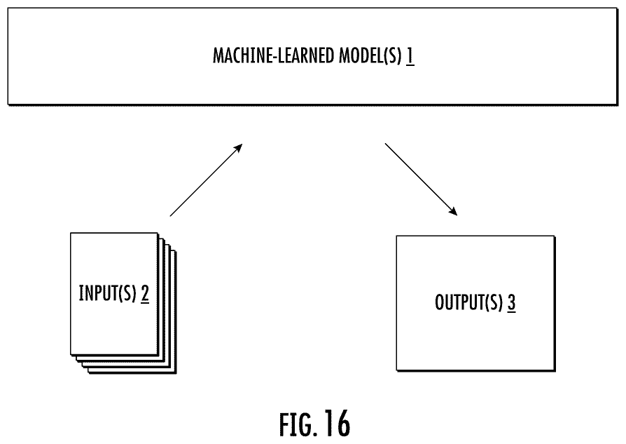

FIG. 16 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

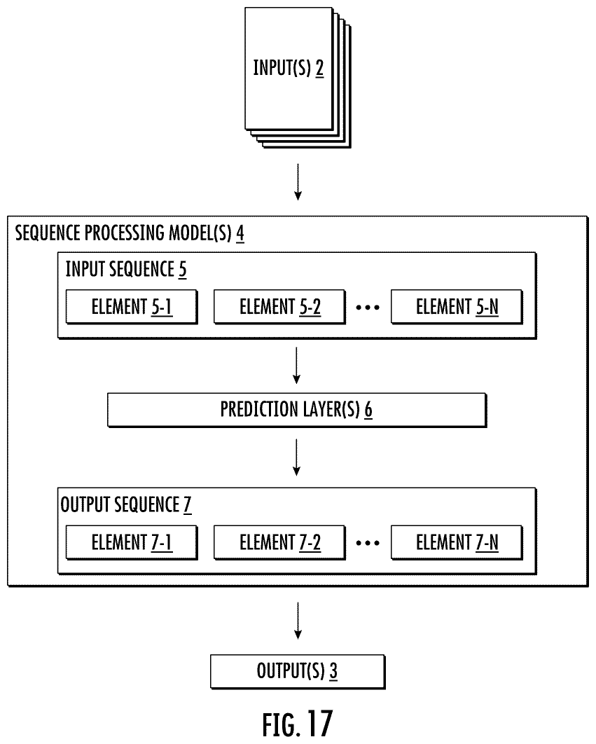

FIG. 17 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 17 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

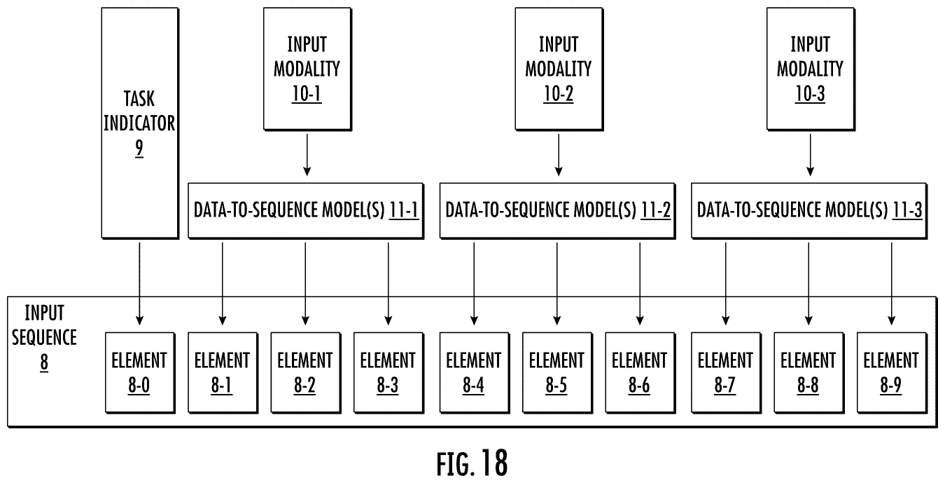

FIG. 18 is a block diagram of an example technique for populating an example input sequence 8. Input sequence 8 can include various functional elements that form part of the model infrastructure, such as an element 8-0 obtained from a task indicator 14 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 14 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned embedding within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

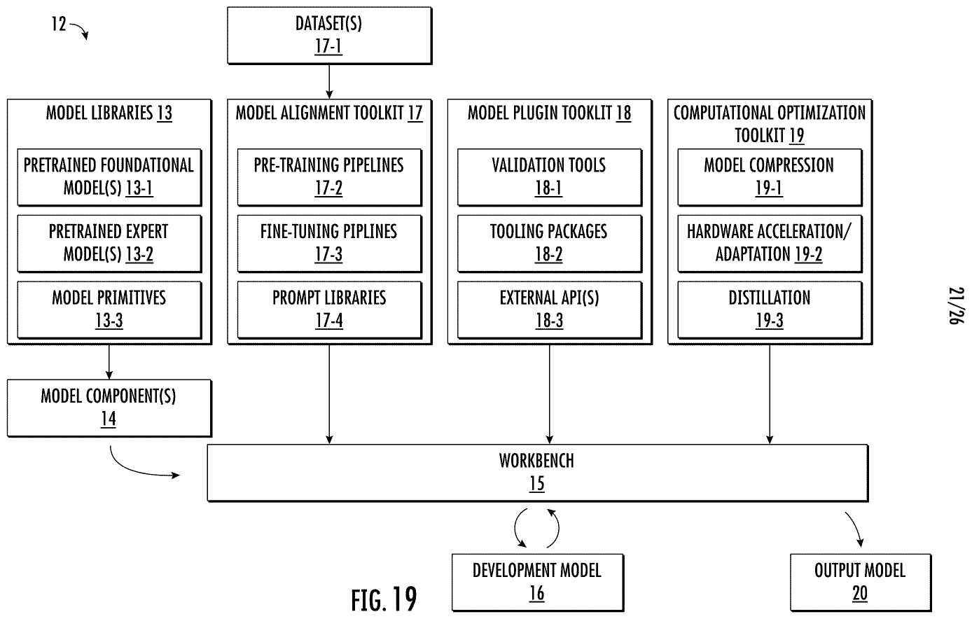

FIG. 19 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1500 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

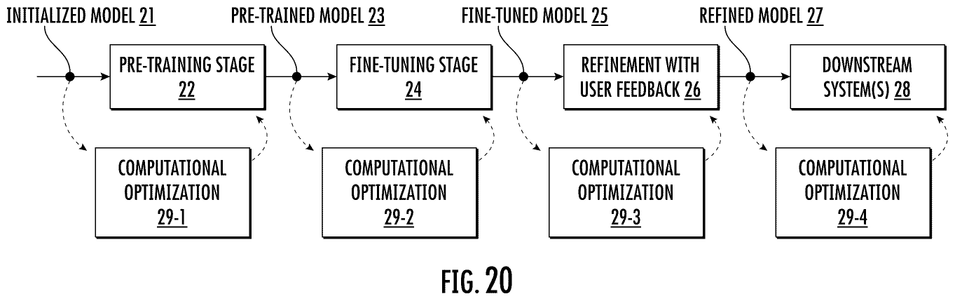

FIG. 20 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 20 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 20 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

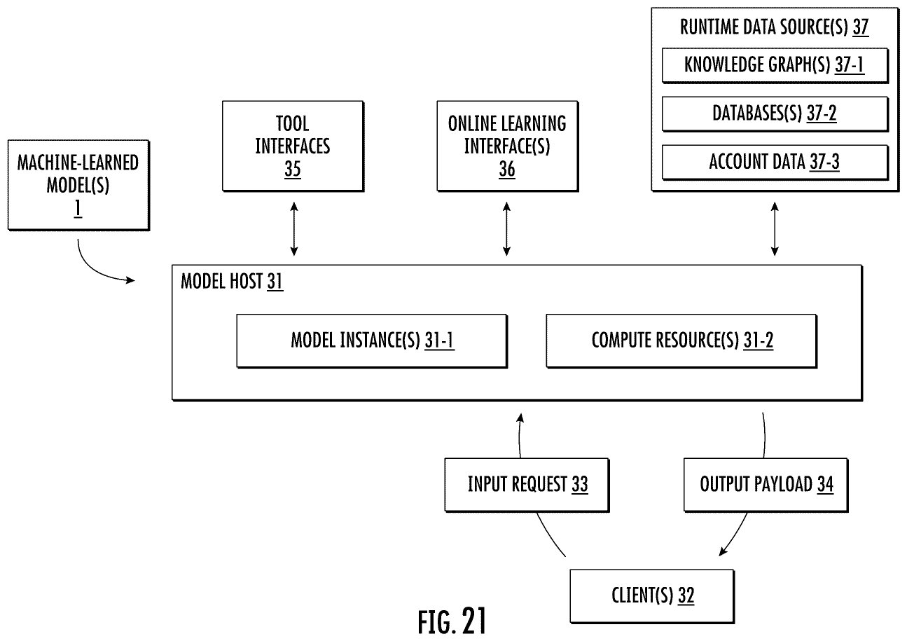

FIG. 21 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also share model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

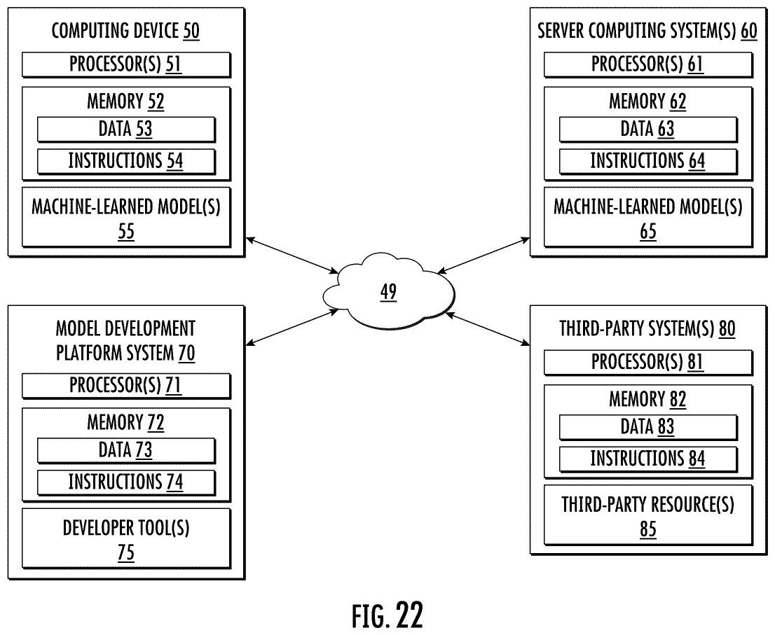

FIG. 22 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 22 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 22 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

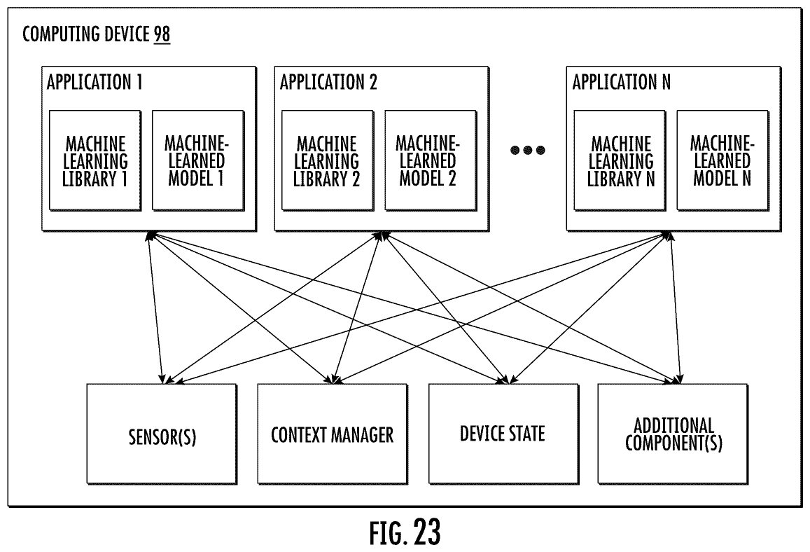

FIG. 23 is a block diagram of an example computing device 148 that performs according to example embodiments of the present disclosure. Computing device 148 can be a user computing device or a server computing device (e.g., computing device 50, server computing system(s) 60, etc.). Computing device 148 can implement model host 31. For instance, computing device 148 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 23, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

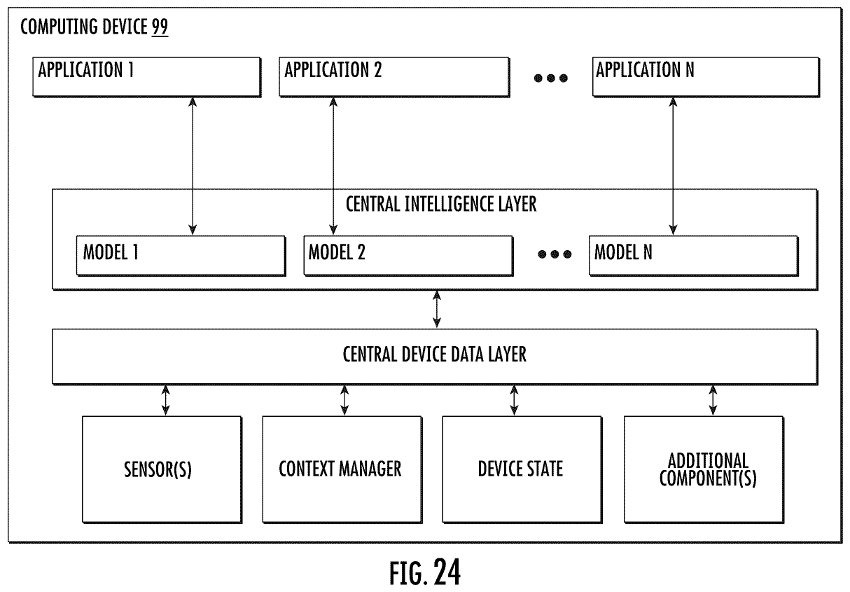

FIG. 24 is a block diagram of an example computing device 149 that performs according to example embodiments of the present disclosure. Computing device 149 can be the same as or different from computing device 148. Computing device 149 can be a user computing device or a server computing device (e.g., computing device 50, server computing system(s) 60, etc.). Computing device 148 can implement model host 31. For instance, computing device 149 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 24, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 149.

The central intelligence layer can communicate with a central device data layer. The central device data layer can be a centralized repository of data for computing device 149. As illustrated in FIG. 24, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, the method comprising:
obtaining, by a computing system comprising one or more processors, a search query;
processing, by the computing system, the search query with a generative model to generate a research outline, wherein the research outline comprises an overview topic prompt and a plurality of sub-topic prompts associated with a topic of the overview topic prompt;
generating, by the computing system and with the generative model, a plurality of model-generated queries based on the research outline, wherein the plurality of model-generated queries comprises a first model-generated query associated with the overview topic prompt and a plurality of second model-generated queries associated with the plurality of sub-topic prompts;
performing, by the computing system and based on the plurality of model-generated queries, a plurality of searches to determine a plurality of search results sets, wherein each of the plurality of search results sets are associated with a different model-generated query of the plurality of model-generated queries;
processing, by the computing system, the search query, the research outline, and at least a subset of each set of the plurality of search results sets with the generative model to generate a model-generated research synthesis, wherein the model-generated research synthesis comprises a distillation of information identified from at least the subset of each set of the plurality of search results sets determined to be responsive to the overview topic prompt and the plurality of sub-topic prompts; and
providing, by the computing system, the model-generated research synthesis for display.

2. The method of claim 1, further comprising:
processing, by the computing system, the search query with a compact generative model to determine a query task classification.

3. The method of claim 2, wherein the query classification is descriptive of at least one of a general search task type, a medical diagnostic task type, or a research task type.

4. The method of claim 3, wherein:
when the query classification is descriptive of the general search task type:
processing the search query with a search engine to determine a plurality of general search results; and
providing the plurality of general search results for display within a search results interface;
when the query classification is descriptive of the medical diagnostic task type:
providing an image of the search query to a medical conditions classification model based on the query classification;
processing the image with the medical conditions classification model to generate a predicted condition classification, wherein the predicted condition classification is descriptive of a candidate medical condition determined to be potentially depicted in the image; and
providing medical condition information associated with the candidate medical condition; and
when the query classification is descriptive of the research task type:
transmitting the search query to the generative model.

5. The method of claim 2, wherein processing, by the computing system, the search query with the compact generative model to determine the query task classification comprises:
determining, by the computing system and with the compact generative model, that the search query is associated with a research task type; and
in response to determining, with the compact generative model, that the search query is associated with the research task type, transmitting the search query to a research query processing system.

6. The method of claim 5, wherein transmitting the search query to the research query processing system comprises:
transmitting the search query to the generative model.

7. The method of claim 1, wherein the generative model was trained on chain-of-thought reasoning by training the generative model to breakdown a requested task into sub-tasks then incrementally performing the sub-tasks in order to perform the requested task, wherein the generative model was fine-tuned to generate research-focused outlines based on receiving a query, and wherein the generative model is communicatively connected with a plurality of external tools and was trained to interface with the plurality of external tools to perform the sub-tasks.

8. The method of claim 1, wherein the operations further comprise:
storing, by the computing system and in a cache, data descriptive of the at least the subset of each set of the plurality of search results sets and the model-generated research synthesis;
obtaining a follow-up query, wherein the follow-up query is related to a query topic of the search query;
generating a follow-up query response based on a preserved context associated with the data descriptive of the at least the subset of each set of the plurality of search results sets and the model-generated research synthesis stored in the cache; and
providing the follow-up query response for display.

9. The method of claim 1, wherein the search query comprises a text string and an input document.

10. The method of claim 1, wherein the query comprises a multimodal query comprising image data and text data, wherein the generative model comprises a vision language model, and wherein the research outline comprises a multimodal outline.

11. A computing system, the system comprising:
one or more processors; and
one or more non-transitory computer-readable media that collectively store instructions that, when executed by the one or more processors, cause the computing system to perform operations, the operations comprising:
obtaining a query, wherein the query comprises a plurality of features;
processing the query with a search engine to determine a plurality of search results based on the plurality of features;
processing the query with a classification model to determine a query classification descriptive of a particular query type of a plurality of different query types, wherein the particular query type is descriptive of the query requesting a research task be performed associated with a broad information request for a particular topic;
in response to the query classification being descriptive of the particular query type, processing the query, a subset of plurality of search results, and a particular prompt with a generative model to generate a plurality of sub-topics and a plurality of sub-topic queries, wherein the plurality of sub-topics are associated with a topic of information responsive to the query, and wherein the plurality of sub-topic queries are associated with the plurality of sub-topics;
processing the plurality of sub-topic queries to determine a plurality of sub-topic search result sets, wherein each of the plurality of sub-topic search result sets is associated with a different sub-topic query of the plurality of sub-topic queries;
processing the query, the plurality of sub-topics, and the plurality of sub-topic search result sets with the generative model to generate a multi-part response comprising a plurality of sub-topic headers and a plurality of sub-topic descriptions; and
providing the multi-part response for display in a search results interface.

12. The system of claim 11, wherein the operations further comprise:
processing the query with a first query classification model to determine a first query classification; and
determining to provide the query to the classification model based on the first query classification.

13. The system of claim 12, wherein the operations further comprise:
providing the query and the subset of plurality of search results to the generative model based on the first query classification;
processing the query and the subset of plurality of search results with the generative model to generate a first model-generated response, wherein the first model-generated response comprises a response to the query generated based on the content of the subset of plurality of search results; and
providing the first model-generated response for display within the search results interface.

14. The system of claim 11, wherein the operations further comprise:
before processing the query, the subset of the plurality of search results, and the particular prompt with the generative model to generate the plurality of sub-topics and the plurality of sub-topic queries:
providing a portion of the plurality of the search results for display with a selectable user interface element associated with performing generative model processing.

15. The system of claim 11, wherein the operations, further comprise:
obtaining a selection of the selectable user interface element; and
providing the query, the subset of the plurality of search results, and the particular prompt to the generative model based on the selection.

16. The system of claim 11, wherein providing the multi-part response for display in the search results interface comprises:
providing the multi-part response for display with a portion of the plurality of search results.

17. The system of claim 11, wherein processing the query, the plurality of sub-topics, and the plurality of sub-topic search result sets with the generative model to generate the multi-part response comprises:
generating an introduction and a conclusion comprising information responsive to the query;
generating the plurality of sub-topic headers based on the plurality of sub-topics;
generating the plurality of sub-topic descriptions based on the plurality of sub-topic search result sets; and
generating the multi-part response comprising a structured format of the introduction, the plurality of sub-topic headers, the plurality of sub-topic descriptions, and the conclusion.

18. The system of claim 11, wherein the plurality of sub-topic queries comprise a plurality of model-generated queries generated to obtain information associated with the plurality of sub-topics.

19. The system of claim 11, wherein the plurality of sub-topic search result sets are determined based on one or more knowledge graphs.

20. The system of claim 11, wherein the multi-part response comprises the plurality of sub-topic headers are presented in bold, wherein the plurality of sub-topic descriptions are collapsable within the search results interface, and wherein each of the plurality of sub-topic descriptions are presented with one or more respective search results from the plurality of sub-topic search result sets.

21. One or more non-transitory computer-readable media that collectively store instructions that, when executed by one or more computing devices, cause the one or more computing devices to perform operations, the operations comprising:
obtaining, via a search interface and from a user computing device, a search query associated with a user request for information;
determining the search query is associated with a research-and-synthesis search task type;
in response to determining the search query is associated with the research-and-synthesis search task type, processing the search query with a generative model to generate a model-generated question associated with receiving additional information of the user request;
providing the model-generated question to the user computing device via the search interface;
obtaining, via the search interface and from the user computing device, an additional input in response to the model-generated question;
processing the search query and the additional input with the generative model to generate a research outline, wherein the research outline comprises an overview topic prompt, a plurality of sub-topic prompts associated with a topic of the overview topic prompt, and a search call associated with a plurality of resources to query to obtain information on the overview topic prompt and the plurality of sub-topic prompts;
performing, based on the overview topic prompt and the search call, a first search to determine a plurality of first search results associated with the overview topic prompt, wherein the plurality of first search results are determined by searching a first subset of the plurality of resources based on the search call;
performing, based on the plurality of sub-topic prompts and the search call, a plurality of second searches to determine a plurality of respective second search result sets associated with the plurality of sub-topic prompts, wherein the plurality of respective second search result sets are determined by, for each of the plurality of sub-topic prompts, searching a respective second subset of the plurality of resources based on the search call;
processing the search query, the research outline, at least a subset of the plurality of first search results, and at least a subset of the plurality of respective second search result sets with the generative model to generate a model-generated research synthesis, wherein the model-generated research synthesis comprises a detailed and organized distillation of information identified from at least the subset of the plurality of first search results and at least the subset of the plurality of respective second search result sets determined to be responsive to the overview topic prompt and the plurality of sub-topic prompts;
generating a model-generated response based on the model-generated research synthesis; and
providing the model-generated response to the user computing device via the search interface.

22. The one or more non-transitory computer-readable media of claim 21, wherein the operations further comprise:
obtaining, via the search interface and from the user computing device, a follow-up query, wherein the follow-up query is related to a topic of the search query;
processing the follow-up query and the model-generated research synthesis with the generative model to generate a second model-generated response, wherein the second model-generated response is responsive to the follow-up query and based on content of the model-generated research synthesis; and
providing the second model-generated response to the user computing device via the search interface.

23. The one or more non-transitory computer-readable media of claim 22, wherein processing the follow-up query and the model-generated research synthesis with the generative model to generate the second model-generated response comprises:
determining, with the generative model and based on the model-generated research synthesis, a particular resource is associated with the follow-up query; and
processing the follow-up query and the particular resource with the generative model to generate the second model-generated response.

24. The one or more non-transitory computer-readable media of claim 21, wherein the model-generated response comprises a plurality of embedded citations, wherein the plurality of embedded citations comprise links to a plurality of respective resources associated with different parts of the model-generated response, and wherein the plurality of respective resources comprise at least the subset of the plurality of first search results and at least the subset of the plurality of respective second search result sets.
